(19) United States
(12) Patent Application Publication
(10) Pub. No.: US 2022/0345957 A1
(43) Pub. Date: Oct. 27, 2022

(54) MASTER CELL GROUP FAILURE WHILE THERE IS AN ONGOING SECONDARY CELL GROUP CHANGE

(71) Applicant: TELEFONAKTIEBOLAGET LM ERICSSON (PUBL), Stockholm (SE)

(72) Inventors: Patrik Rugeland, BROMMA (SE); Oumer Teyeb, MONTRÉAL (CA)

(21) Appl. No.: 17/765,066

(22) PCT Filed: Oct. 8, 2020
(86) PCT No.: PCT/IB2020/059481

§ 371 Date: Mar. 30, 2022

Related U.S. Application Data
(60) Provisional application No. 62/912,750, filed on Oct. 9, 2019.

(51) Int. Cl. H04W 36/00; H04W 36/30

(52) U.S. Cl. CPC H04W 36/0069; H04W 36/305

(57) ABSTRACT

A communication device configured to operate in dual connectivity (DC) with a master node (MN) and a secondary node (SN) can be configured with a master cell group (MCG) configuration associated with the MN and a secondary cell group (SCG) configuration associated with the SN. The communication device can detect a radio link failure on the MCG. The communication device can further determine whether a primary secondary cell group cell (PSCell) change procedure is ongoing. The communication device can further respond to the radio link failure on the MCG based on whether the PSCell change procedure is ongoing.

### TECHNICAL FIELD

The present disclosure relates generally to communication, and more particularly to handling a master cell group (“MCG”) failure while there is an ongoing secondary cell group (“SCG”) change.

### BACKGROUND

5^{th} Generation (“5G”) in 3^{rd} Generation Partnership Project (“3GPP”) introduces both a new core network (“5GC”) and a new radio access network (“NR”). The 5GC can, however, also support other radio access technologies (“RATs”) than NR. It has been agreed that long term evolution (“LTE”) (or evolved universal terrestrial radio access (“E-UTRA”)) should also be connected to a 5GC and that an LTE base station that is connected to a 5GC is called a ng-eNB and is part of a 5^{th} generation radio access network (“NG-RAN”), which can also include NR base stations (“gNBs”). FIG. 1 illustrates how base stations are connected to each other and the nodes in a 5GC.

In 3GPP, dual-connectivity (“DC”) has been specified, both for LTE and between LTE and NR. In DC two nodes can be involved, a master node (“MN or MeNB”) and a Secondary Node (“SN, or SeNB”). Multi-connectivity (“MC”) is the term used for when there are more than 2 nodes involved. Also, it has been proposed in 3GPP that DC is used in the Ultra Reliable Low Latency Communications (“URLLC”) cases in order to enhance the robustness and to avoid connection interruptions.

There are different ways to deploy a 5G network with or without interworking with LTE (also referred to as E-UTRA) and an evolved packet core (“EPC”), as depicted in FIGS. 2-7. In principle, NR and LTE can be deployed without any interworking, denoted by NR stand-alone (“SA”) operation, that is gNB in NR can be connected to a 5GC and an eNB can be connected to an EPC with no direct interconnection on a RAN level between the two (e.g., in FIGS. 2-3). On the other hand, the first supported version of NR is the E-UTRAN-NR Dual Connectivity (“EN-DC”), illustrated in FIG. 4. In such a deployment, dual connectivity between NR and LTE is applied with LTE as the master and NR as the secondary node. The RAN node (gNB) supporting NR, may not have a control plane connection to the EPC, instead it can rely on the LTE as master node (“MeNB”). This can also be called a non-standalone (“NSA”) NR. Functionality of an NSA NR can be limited and can be used for connected mode UEs as a booster and/or diversity leg, but an RRC_IDLE UE may not be able to camp on these NR cells. An NR Cell can be capable of acting as a “Non-standalone cell” towards one user equipment or wireless device (“UE”) at the same time as acting as a “Standalone cell” to other UE's. To be able to act as a “Standalone cell,” the gNB supporting the NR cell may need to be connected to the 5GC.

With introduction of a 5GC, other options may be also valid. As mentioned above, FIG. 3 supports stand-alone NR deployment where gNB is connected to 5GC. Similarly, LTE can also be connected to 5GC as illustrated in FIG. 6 (also known as eLTE, E-UTRA/5GC, or LTE/5GC and the node can be referred to as an ng-eNB). In these cases, both NR and LTE are seen as part of the NG-RAN (and both the ng-eNB and the gNB can be referred to as NG-RAN nodes). FIGS. 5 and 8 illustrate other variants of dual connectivity between LTE and NR which will be standardized as part of NG-RAN connected to 5GC, denoted by multi-RAT dual connectivity (“MR-DC”). EN-DC (illustrated in FIG. 4), NE-DC (illustrated in FIG. 5), NGEN-DC (illustrated in FIG. 7), and NR-DC (a variant of what is illustrated in FIG. 3) may fall under the MR-DC umbrella. FIG. 4 depicts an EN-DC in which the LTE is the master node and NR is the secondary (EPC CN employed). FIG. 5 depicts an NE-DC in which the NR is the master node and LTE is the secondary (SGCN employed). FIG. 7 depicts an NGEN-DC in which the LTE is the master node and NR is the secondary (SGCN employed). A variant of FIG. 3 could depict an NR-DC in which there is dual connectivity where both the master and secondary are NR (SGCN employed).

As migration for these options may differ from different operators, it is possible to have deployments with multiple options in parallel in the same network. For example, there could be eNB base station supporting the options illustrated in FIGS. 4, 6, and 7 in the same network as NR base station supporting the options illustrated in FIGS. 3 and 5. In combination with dual connectivity solutions between LTE and NR, it is also possible to support carrier aggregation (“CA”) in each cell group (e.g., a master cell group (“MCG”) and a secondary cell group (“SCG”)) and dual connectivity between nodes of the same RAT (e.g. new radio new radio dual connectivity (“NR-NR DC”)). For the LTE cells, a consequence of these different deployments is the co-existence of LTE cells associated to eNBs connected to EPC, 5GC or both EPC/5GC.

If a MCG link failure occurs during a SCG change, a delay in communication of MCG failure information may occur and/or the MCG failure information may never reach the MN.

### SUMMARY

According to some embodiments, a method of operating a communication device is provided. The communication device can be configured to operate in dual connectivity (“DC”) with a master node (“MN”) and a secondary node (“SN”) and configured with a master cell group (“MCG”) configuration associated with the MN and a secondary cell group (SCG″) configuration associated with the SN. The method can include detecting a radio link failure on the MCG. The method can further include determining whether a primary secondary cell group cell (“PSCell”) change procedure is ongoing. The method can further include responding to the radio link failure on the MCG based on whether the PSCell change procedure is ongoing.

According to other embodiments, a method of operating a first network node in a communications network is provided. The communication network can include a communication device configured to operate in dual connectivity (“DC”) with a master node (“MN”) and a secondary node (“SN”) and the first network node can be the MN. The method can include transmitting a first message to a target SN as part of a primary secondary cell group cell (“PSCell”) change procedure being performed by the communication device. The method can further include detecting a radio link failure between the first network node and the communication device. The method can further include, responsive to detecting the radio link failure, transmitting a second message to the target SN.

According to other embodiments, a network node, communication device, computer program, and/or computer program product is provided for performing one or more of the above methods.

Various embodiments described herein allow a UE and a network to avoid any ambiguity with regards to SCG configurations in response to a MCG failure during a PSCell/SCG change.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a diagram illustrating an example of 5^{th} Generation System (“5GS”) architecture including a 5GC and a NG-RAN;

FIGS. 2-7 are diagrams illustrating examples of LTE and NR interworking options;

FIG. 8 is a block diagram illustrating an example of control plane architecture for dual connectivity in LTE DC and EN-DC according to some embodiments of the present disclosure;

FIG. 9 is a block diagram illustrating an example of network side protocol termination options for MCG, SCG, and split bearers in MR-DC with EPC (EN-DC) according to some embodiments of the present disclosure;

FIG. 10 is a block diagram illustrating an example of network architecture for control plane in EN-DC according to some embodiments of the present disclosure;

FIG. 11 is a block diagram illustrating an example of radio link failure due to physical layer problems according to some embodiments of the present disclosure;

FIG. 12 is a table illustrating an example of a timer according to some embodiments of the present disclosure;

FIG. 13 is a table illustrating an example of a constant according to some embodiments of the present disclosure;

FIG. 14 is a signal flow diagram illustrating an example of SCG failure information according to some embodiments of the present disclosure;

FIG. 15 is a signal flow diagram illustrating an example of MCG failure information according to some embodiments of the present disclosure;

FIG. 16 is a block diagram illustrating an example of a wireless device (“UE”) according to some embodiments of the present disclosure;

FIG. 17 is a block diagram illustrating an example of a radio access network (“RAN”) node (e.g., a base station eNB/gNB) according to some embodiments of the present disclosure;

FIG. 18 is a block diagram illustrating an example of a core network (“ON”) node (e.g., an AMF node, an SMF node, an OAM node, etc.) according to some embodiments of the present disclosure;

FIG. 19 is a flow chart illustrating an example of a process performed by a wireless device according to some embodiments of the present disclosure;

FIG. 20 is a flow chart illustrating an example of a process performed by a network node according to some embodiments of the present disclosure;

FIG. 21 is a block diagram of a wireless network in accordance with some embodiments;

FIG. 22 is a block diagram of a user equipment in accordance with some embodiments

FIG. 23 is a block diagram of a virtualization environment in accordance with some embodiments;

FIG. 24 is a block diagram of a telecommunication network connected via an intermediate network to a host computer in accordance with some embodiments;

FIG. 25 is a block diagram of a host computer communicating via a base station with a user equipment over a partially wireless connection in accordance with some embodiments;

FIG. 26 is a block diagram of methods implemented in a communication system including a host computer, a base station, and a user equipment in accordance with some embodiments;

FIG. 27 is a block diagram of methods implemented in a communication system including a host computer, a base station, and a user equipment in accordance with some embodiments;

FIG. 28 is a block diagram of methods implemented in a communication system including a host computer, a base station, and a user equipment in accordance with some embodiments; and

FIG. 29 is a block diagram of methods implemented in a communication system including a host computer, a base station, and a user equipment in accordance with some embodiments.

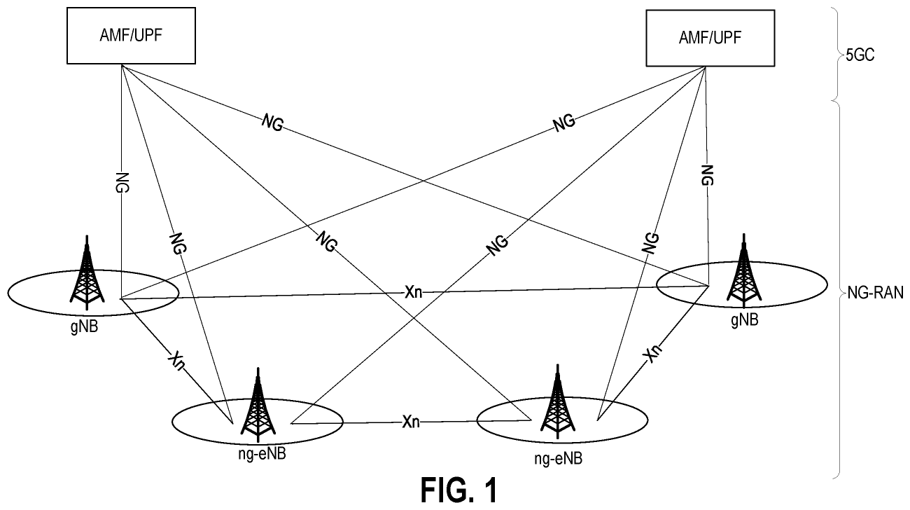

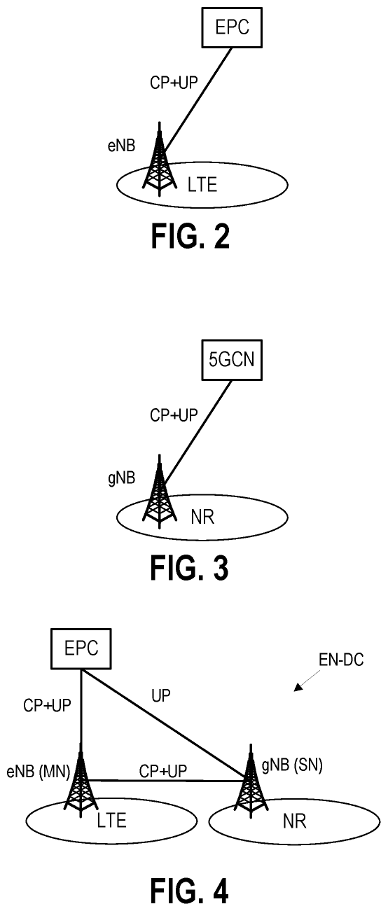

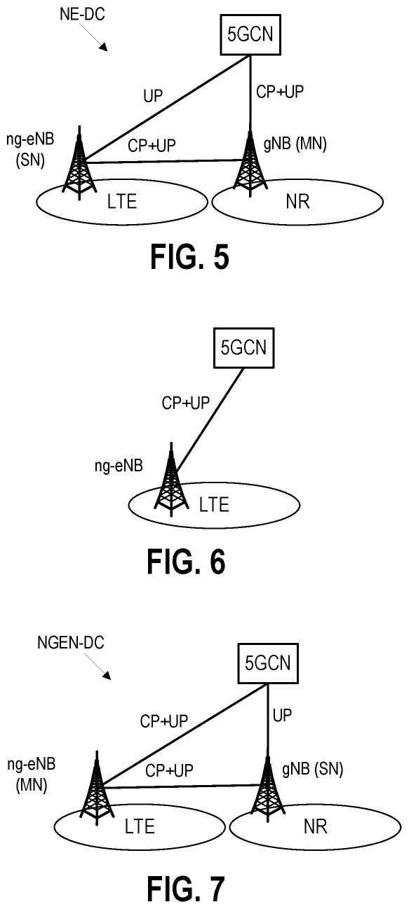

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

DC can be standardized for both LTE and E-UTRA-NR DC (EN-DC). LTE DC and EN-DC can be designed differently when it comes to which nodes control what. Two examples include: a centralized embodiment (e.g., LTE-DC) and a decentralized embodiment (e.g., EN-DC).

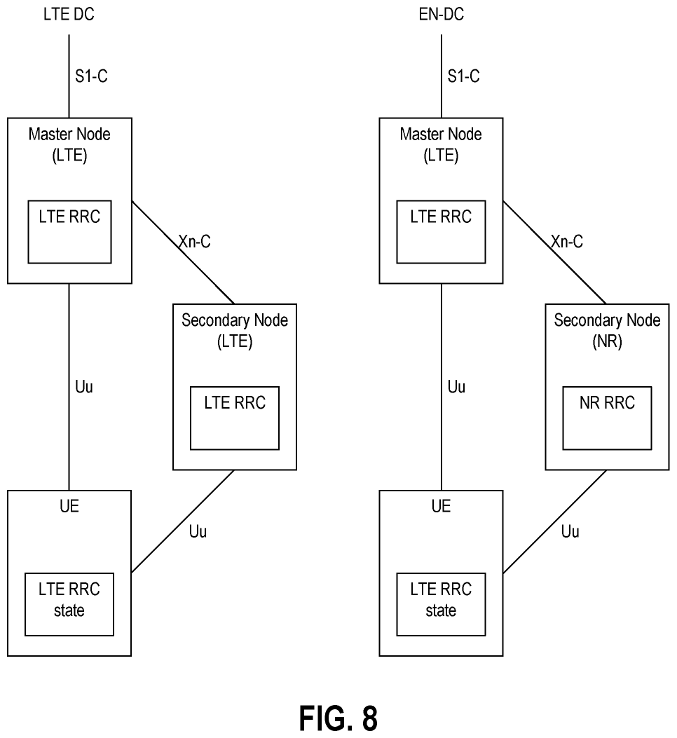

FIG. 8 illustrates an example of a schematic control plane architecture for LTE DC and EN-DC. In EN-DC, the SN can have a separate RRC entity (NR RRC). The SN can control the UE and sometimes without the knowledge of the MN though the SN may need to coordinate with the MN. In LTE-DC, the RRC decisions can come from the MN (e.g., MN to UE). The SN may still decide the configuration of the SN as the SN may be the only node that has knowledge of the resources and capabilities of the SN.

Differences between EN-DC and LTE DC can include an introduction of split bearer from the SN (known as SCG split bearer), an introduction of split bearer for RRC, and an introduction of a direct RRC from the SN (also referred to as SCG SRB).

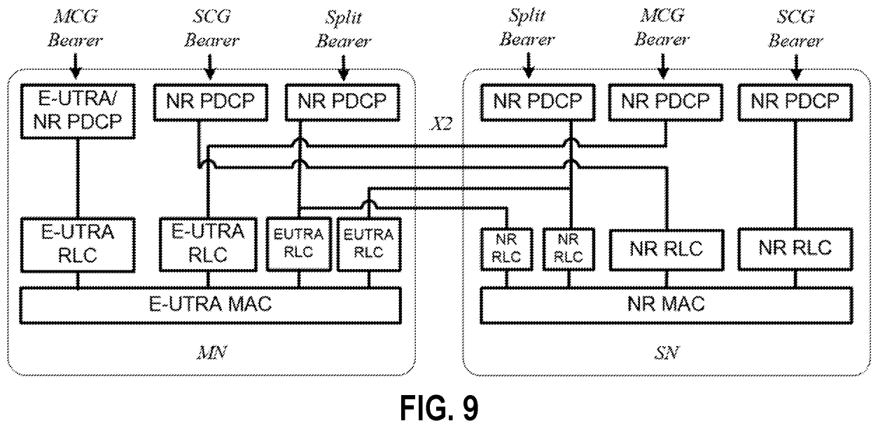

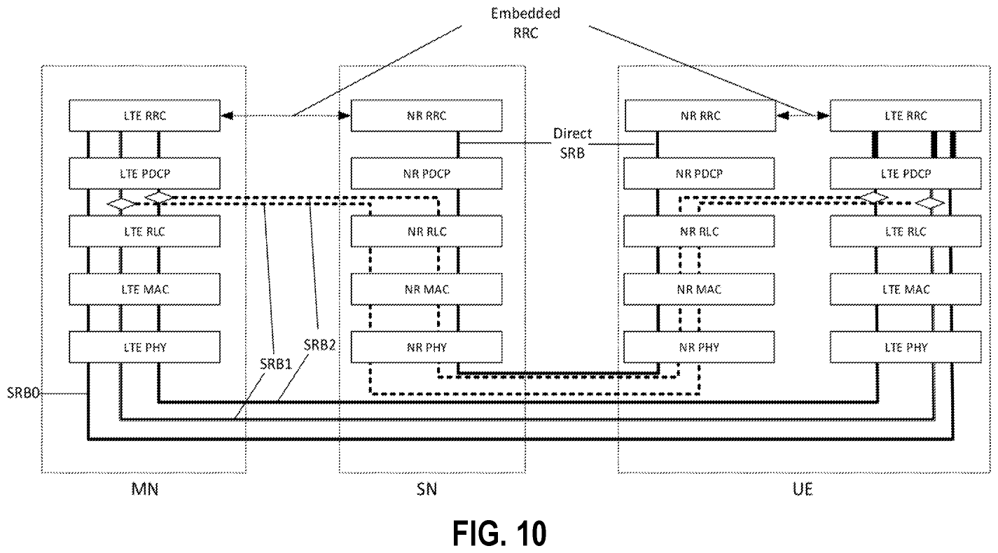

FIGS. 9-10 depict examples of the user plane (“UP”) and control plane (“UP”) architecture for EN-DC.

The SN can be referred to as SgNB (where gNB is an NR base station), and the MN as MeNB in case the LTE is the master node and NR is the secondary node. In the other case where NR is the master node and LTE is the secondary node, the corresponding terms are SeNB and MgNB.

Split RRC messages can be used for creating diversity, and the sender can decide to either choose one of the links for scheduling the RRC messages, or it can duplicate the message over both links. In the downlink, the path switching between the MCG or SCG legs or duplication on both can be left to network implementation. For the UL, the network can configure the UE to use the MCG, SCG or both legs. The terms “leg”, “path” and “RLC bearer” are used interchangeably throughout this document.

When carrier aggregation (“CA”) is configured, the UE may have only one RRC connection with the network. Further, at RRC connection establishment/re-establishment/handover, one serving cell provides the NAS mobility information, and at RRC connection re-establishment/handover, one serving cell provides the security input. This cell can be referred to as the Primary Cell (“PCell”). In addition, depending on UE capabilities, Secondary Cells (“SCells”) can be configured to form together with the PCell a set of serving cells. The configured set of serving cells for a UE therefore always consists of one PCell and one or more SCells. Further, when dual connectivity is configured, it could be the case that one carrier under the SCG is used as the PSCell. Hence, in this case we have one PCell and one or more SCell(s) over the MCG and one PSCell and one or more SCell(s) over the SCG.

The reconfiguration, addition, and removal of SCells can be performed by RRC. At intra-RAT handover, RRC can also add, remove, or reconfigure SCells for usage with the target PCell. When adding a new SCell, dedicated RRC signaling is used for sending all required system information of the SCell i.e. while in connected mode, UEs need not acquire broadcasted system information directly from the SCells.

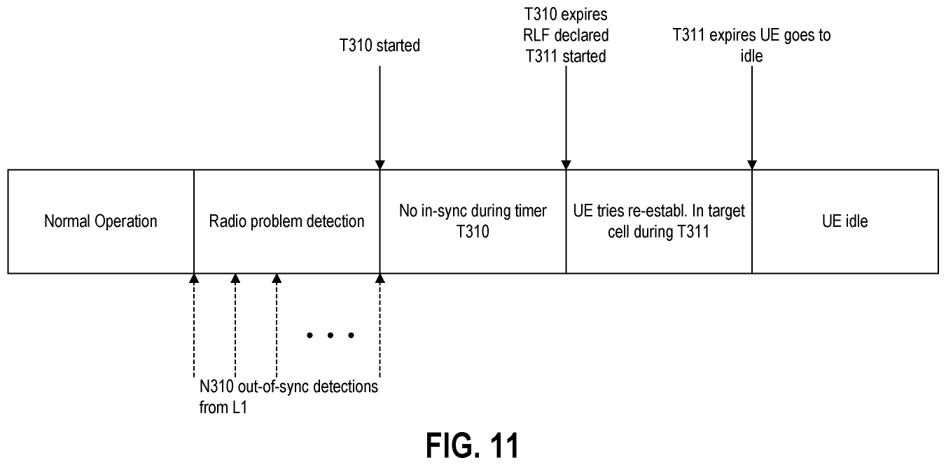

FIG. 11 is a block diagram depicting radio link failure due to physical layer problems. It may occur that a UE loses coverage to the cell that the UE is currently connected to. This could occur in a situation when a UE enters a fading dip, or that a handover was needed as described above, but the handover failed for one or another reason. This is particularly true if the “handover region” is very short, as will be further described below.

The quality of the radio link can be monitored in the UE (e.g. on the physical layer, as described in 3GPP TS 38.300, TS 38.331 and TS 38.133). Upon detection that the physical layer experiences problems according to criteria defined in TS 38.133, the physical layer sends an indication to the RRC protocol of the detected problems (out-of-sync indication).

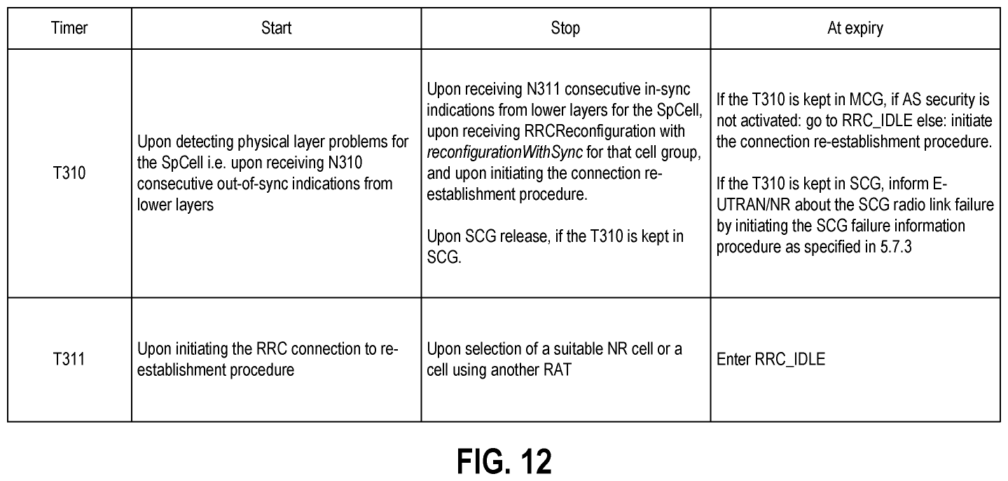

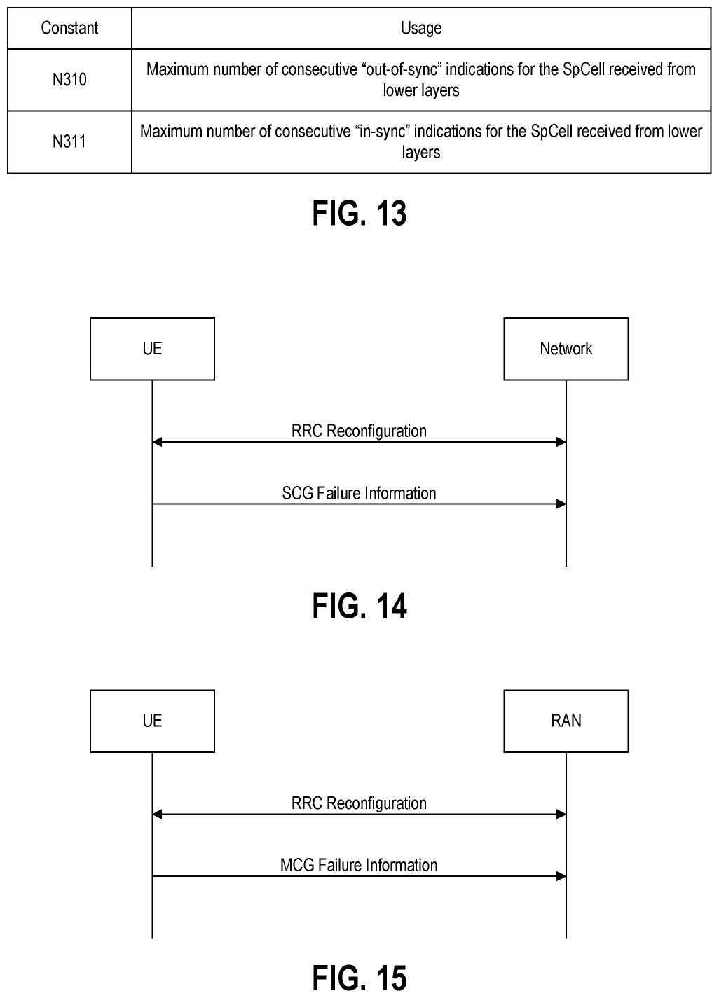

Some timers and counters described above are illustrated in the tables of FIGS. 12-13. The table in FIG. 12 describes the start, stop, and expiration of MCG Timer T310 and Timer T311. The table in FIG. 13 describes the usage of an out-of-sync constant N310 and an in-sync constant N311. After a configurable number (e.g., out-of-sync constant N310) of such consecutive indications, timer T310 can be started. If the link quality is not improved (recovered) while timer T310 is running (e.g., there are not an in-sync number N311 consecutive indications from the physical layer), a radio link failure is declared in the UE, see FIG. 11.

The UE reads the timer-values from system information broadcasted in the cell. Alternatively, it is possible to configure the UE with UE-specific values of the timers and constants using dedicated signaling, i.e. where specific values are given to specific UEs with messages directed only to each specific UE.

If timer T310 expires for MCG, and as seen above, the UE initiates a connection re-establishment to recover the ongoing RRC connection. This procedure now includes cell selection by the UE. I.e. the RRC_CONNECTED UE shall now try to autonomously find a better cell to connect to, since the connection to the previous cell failed according to the described measurements (it could occur that the UE returns to the first cell anyway, but the same procedure is also then executed). Once a suitable cell is selected (as further described e.g. in TS 38.304), the UE requests to re-establish the connection in the selected cell. It is important to note the difference in mobility behavior as an RLF results in UE based cell selection, in contrast to the normally applied network-controlled mobility.

If the re-establishment is successful (which depends, among other things, if the selected cell and the gNB controlling that cell was prepared to maintain the connection to the UE), then the connection between the UE and the gNB can resume.

A failure of a re-establishment means that the UE goes to RRC_IDLE and the connection is released. To continue communication, a brand new RRC connection has then to be requested and established.

The reason for introducing the timers T310, T311 and counters N310, 311 described above is to add some freedom and hysteresis for configuring the criteria for when a radio link should be considered as failed (and recovered). This is desirable, since it would hurt the end-user performance if a connection is abandoned prematurely if it turned out that the loss of link quality was temporary, and the UE succeeded in recovering the connection without any further actions or procedures (e.g. before timer T310 expires, or before the counting reaches value N310).

FIG. 14 is a signal flow diagram illustrating an example of a process for providing SCG failure information. This process can inform E-UTRAN or NR MN about an SCG failure the UE has experienced i.e. SCG radio link failure, failure of SCG reconfiguration with sync, SCG configuration failure for RRC message on SRB3 and SCG integrity check failure. A UE can initiate the process to report SCG failures when neither MCG nor SCG transmission is suspended and when one of the following conditions is met: 1) upon detecting radio link failure for the SCG, in accordance with subclause 5.3.10.3; 2) upon reconfiguration with sync failure of the SCG, in accordance with subclause 5.3.5.8.3; 3) upon SCG configuration failure, in accordance with subclause 5.3.5.8.2; or 4) upon integrity check failure indication from SCG lower layers concerning SRB3. Upon initiating the procedure, the UE can suspend SCG transmission for all SRBs and DRBs; reset SCG MAC; and stop timer T304, if running. If the UE is in (NG)EN-DC, the UE can initiate transmission of the SCGFailureInformationNR message as specified in TS 36.331 [10], clause 5.6.13a. Otherwise the UE can initiate transmission of the SCGFailureInformation message in accordance with 5.7.3.5.

FIG. 15 is a signal flow diagram illustrating a process for providing MCG failure information. This process can inform NR MN about an MCG failure the UE has experienced (e.g., a MCG radio link failure). A UE configured with split SRB1 can initiate the process to report MCG failures when SCG transmission is not suspended and upon detecting radio link failure of the MCG, in accordance with 5.3.10.3

Upon initiating the process, the UE can suspend MCG transmission for all SRBs and DRBs; reset MCG-MAC; and initiate transmission of the MCGFailureInformation message in accordance with 5.7.y.5.

5.7.y.3 Failure type determination

The UE shall set the MCG failure type as follows:

1> if the UE initiates transmission of the MCGFailureInformation message due to T310 expiry:
2> set the failureType as t310-Expiry;

1> else if the UE initiates transmission of the MCGFailureInformation message to provide random access problem indication from MCG MAC:
2> set the failureType as randomAccessProblem;

1> else if the UE initiates transmission of the MCGFailureInformation message to provide indication from MCG RLC that the maximum number of retransmissions has been reached:
2> set the failureType as rlc-MaxNumRetx;

5.7.y.4 Setting the contents of MeasResultMCG-Failure

The UE shall set the contents of the MeasResultMCG-Failure as follows:

Editor's note: FFS how to capture inclusion of MCG, SCG and non-serving cell measurement results

2.1.5.1 5.7.y.5 Actions related to transmission of MCGFailureInformation message

The UE shall set the contents of the MCGFailureInformation message as follows:

1> include and set failureType in accordance with 5.7.y.3;

1> include and set MeasResultMCG-Failure in accordance with 5.7.y.4;

The UE shall submit the MCGFailureInformation message to lower layers for transmission.

According to the current agreements the UE can trigger MCG recovery (if configured) if it detects a failure on the PCell. The UE may then transmit an MCGFailureInformation message via the SCG, either via SRB3 or via the SCG leg of a split SRB1.

If the UE experiences the MCG failure while the UE is performing an PSCell change, either intra-node or inter-node, it is unclear how the network would handle the MCGFailureInformation message and the PSCell.

In addition, there may be some race conditions, as the UE may send the RRCReconfigurationComplete to the MN, acknowledging the reception of the new SCG configurations even before it has started random access procedure towards the new PSCell.

If the UE experiences an MCG failure while it attempts to connect to the new PSCell, there may be a significant delay until it can transmit the MCGFailureInformation via the SCG so that the MN can take appropriate actions to recover the MCG.

Various embodiments herein describe processes for a UE that is operating in dual connectivity with a master node (MN), and a secondary node (SN), where the UE is configured with a master cell group (MCG) configuration associated with the MN and a secondary cell group (SCG) configuration associated with the SN. Some embodiments include detecting a radio link failure on the MCG and determining if there is an ongoing SCG change procedure.

In additional or alternative embodiments, the re-establishment procedure may always be triggered even if the UE is configured with split SRB1 or SRB3 and capable of performing MCG failure recovery procedure.

In additional or alternative embodiments, the re-establishment procedure may only be triggered based on determining that the ongoing SCG change procedure is instructing the UE to change the SN and the MCG failure recovery procedure may be triggered if the SN is not being changed (e.g. PSCell change within the same SN, reconfiguration with sync of the SCG without PSCell change due to key refresh, etc).

In additional or alternative embodiments, the re-establishment procedure may only be triggered based on determining that the ongoing SCG change procedure is instructing the UE to change the PSCell to a cell within the same SN. The MCG failure recovery procedure may only be triggered if the PSCell is not being changed (e.g. reconfiguration with sync of the SCG without PSCell change due to key refresh).

In additional or alternative embodiments, when the MN receives the MCGFailureInformation message after it has sent an RRCReconfiguration message with SCG and/or PSCell modifications but before it has received an RRCReconfigurationComplete message for the SCG and/or PSCell modification, the MN can release an SCG configuration and/or an SN related radio bearer configuration. Regardless of whether the UE has applied the new SCG configurations yet, or is still using the old configurations, the MN can apply full configurations after the failure.

In additional or alternative embodiments, the UE behavior can be configurable. For example, the UE can be configured to perform the MCG failure recovery even if SCG change is ongoing (e.g., T304 is running). This could be for all cases, or it can be for specific cases only (e.g. only if the SN is not being changed or only if the PSCell is not being changed).

In some embodiments, the UE and network can avoid any ambiguity with regards to the SCG configurations at MCG failure during PSCell/SCG change. For example, if the SN initiates an SCG modification or PSCell change without any MN involvement via SRB3, the MN may not know the latest SCG configuration when it receives an MCGFailureInformation. During the SCG change, the UE can send the RRCReconfigurationComplete message to the MN before it has performed the Random Access procedure towards the PSCell, as seen in TS 37.340 v15.7.0. Even if the MN has received indication that the UE has received the new SCG configurations, it may not know whether the UE has successfully applied them or is still attempting to access the PSCell.

If the UE experiences an MCG failure while it attempts to access the PSCell, (e.g., after it has received the RRCReconfiguration message containing the PScell ReconfigurationWithSync), the UE can create the MCGFailureInformation message and attempt to send this via the SCG (e.g., via SRB3 or SCG part of split SRB1).

Since the UE has started synchronizing with the target PSCell, it may have disconnected with the source PSCell and will at the time not have any connection with any network node. The guard timer that is used for MCG failure recovery has to expire (or T304 has to expire) before the UE can re-establish the connection, which can lead to unnecessary delay before the connection. Since the T304 timer can be set to values as large as 10 sec, this means this delay can be quite considerable. By ensuring the re-establishment is triggered when MCG failure is detected while SCG change is ongoing, such unnecessary delays can be prevented, and the performance of the UE can be greatly improved.

In some embodiments, when the UE detects a failure on the MCG, it checks whether there is an ongoing PSCell change (i.e. whether timer T304 for an PSCell is running in NR or timer T307 is not running in LTE). If the timer is running, the UE can perform an RRC Reestablishment. If the timer is not running, the UE can continue with the MCG Failure Information reporting.

In some embodiments, methods are disclosed in order to allow the network to indicate the UE whether the MCG/PCell fast recovery procedure should be used or the UE directly trigger re-establishment procedure.

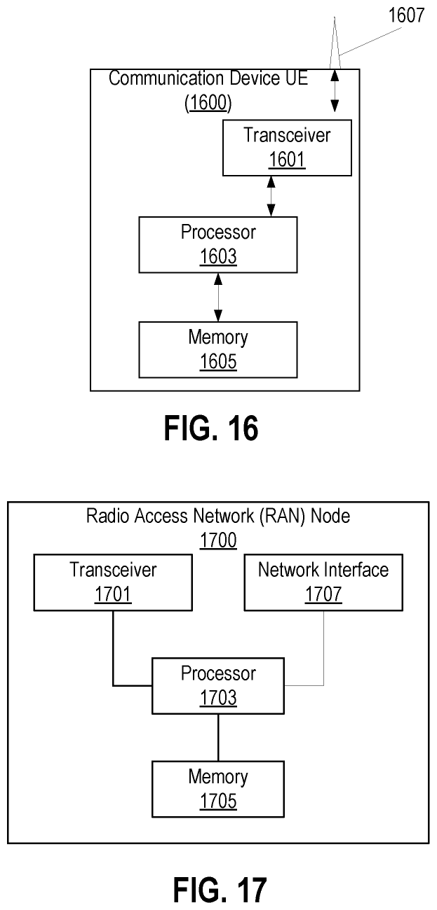

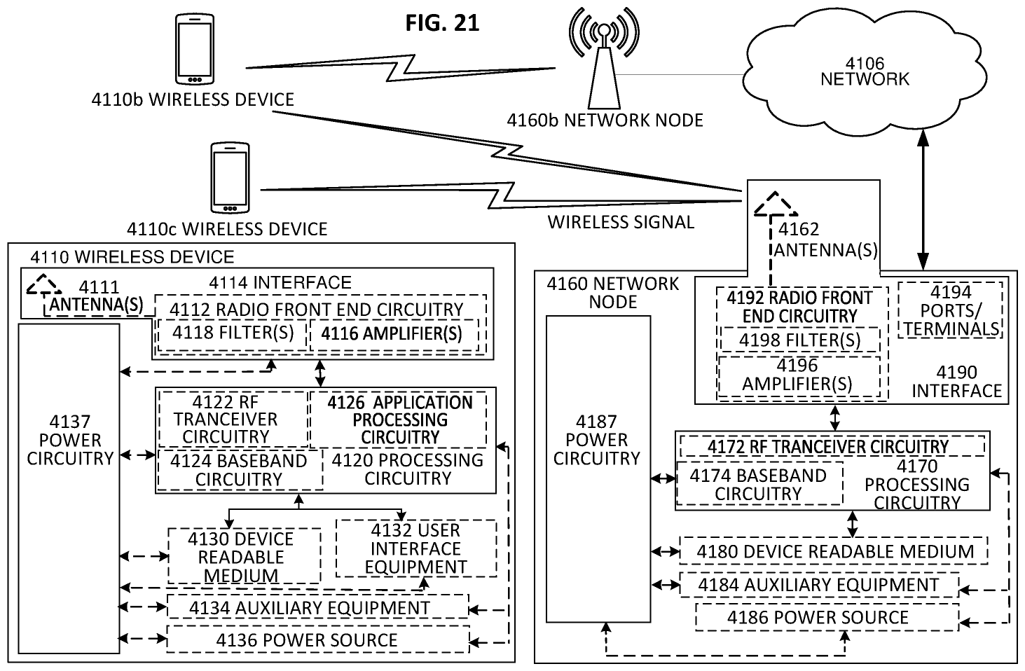

FIG. 16 is a block diagram illustrating elements of a wireless device UE 1600 (also referred to as a mobile terminal, a mobile communication terminal, a wireless communication device, a wireless terminal, a wireless communication terminal, user equipment, UE, a user equipment node/terminal/device, etc.) configured to provide wireless communication according to embodiments of inventive concepts. (Wireless device 1600 may be provided, for example, as discussed below with respect to wireless device 4110 of FIG. 21.) As shown, wireless device UE may include an antenna 1607 (e.g., corresponding to antenna 4111 of FIG. 21), and transceiver circuitry 601 (also referred to as a transceiver, e.g., corresponding to interface 4114 of FIG. 21) including a transmitter and a receiver configured to provide uplink and downlink radio communications with a base station(s) (e.g., corresponding to network node 4160 of FIG. 21) of a radio access network. Wireless device UE may also include processing circuitry 1603 (also referred to as a processor, e.g., corresponding to processing circuitry 4120 of FIG. 21) coupled to the transceiver circuitry, and memory circuitry 1605 (also referred to as memory, e.g., corresponding to device readable medium 4130 of FIG. 21) coupled to the processing circuitry. The memory circuitry 1605 may include computer readable program code that when executed by the processing circuitry 1603 causes the processing circuitry to perform operations according to embodiments disclosed herein. According to other embodiments, processing circuitry 1603 may be defined to include memory so that separate memory circuitry is not required. Wireless device UE may also include an interface (such as a user interface) coupled with processing circuitry 1603, and/or wireless device UE may be incorporated in a vehicle.

As discussed herein, operations of wireless device UE may be performed by processing circuitry 1603 and/or transceiver circuitry 1601. For example, processing circuitry 1603 may control transceiver circuitry 1601 to transmit communications through transceiver circuitry 1601 over a radio interface to a radio access network node (also referred to as a base station) and/or to receive communications through transceiver circuitry 1601 from a RAN node over a radio interface. Moreover, modules may be stored in memory circuitry 1605, and these modules may provide instructions so that when instructions of a module are executed by processing circuitry 1603, processing circuitry 1603 performs respective operations.

FIG. 17 is a block diagram illustrating elements of a radio access network RAN node 1700 (also referred to as a network node, base station, eNodeB/eNB, gNodeB/gNB, etc.) of a Radio Access Network (RAN) configured to provide cellular communication according to embodiments of inventive concepts. (RAN node 1700 may be provided, for example, as discussed below with respect to network node 4160 of FIG. 21.) As shown, the RAN node may include transceiver circuitry 1701 (also referred to as a transceiver, e.g., corresponding to portions of interface 4190 of FIG. 21) including a transmitter and a receiver configured to provide uplink and downlink radio communications with mobile terminals. The RAN node may include network interface circuitry 1707 (also referred to as a network interface, e.g., corresponding to portions of interface 4190 of FIG. 21) configured to provide communications with other nodes (e.g., with other base stations) of the RAN and/or core network CN. The network node may also include a processing circuitry 1703 (also referred to as a processor, e.g., corresponding to processing circuitry 4170) coupled to the transceiver circuitry, and a memory circuitry 1705 (also referred to as memory, e.g., corresponding to device readable medium 4180 of FIG. 21) coupled to the processing circuitry. The memory circuitry 1705 may include computer readable program code that when executed by the processing circuitry 1703 causes the processing circuitry to perform operations according to embodiments disclosed herein. According to other embodiments, processing circuitry 1703 may be defined to include memory so that a separate memory circuitry is not required.

As discussed herein, operations of the RAN node may be performed by processing circuitry 1703, network interface 1707, and/or transceiver 1701. For example, processing circuitry 1703 may control transceiver 1701 to transmit downlink communications through transceiver 1701 over a radio interface to one or more mobile terminals UEs and/or to receive uplink communications through transceiver 1701 from one or more mobile terminals UEs over a radio interface. Similarly, processing circuitry 1703 may control network interface 1707 to transmit communications through network interface 707 to one or more other network nodes and/or to receive communications through network interface from one or more other network nodes. Moreover, modules may be stored in memory 1705, and these modules may provide instructions so that when instructions of a module are executed by processing circuitry 1703, processing circuitry 1703 performs respective operations.

According to some other embodiments, a network node may be implemented as a core network CN node without a transceiver. In such embodiments, transmission to a wireless device UE may be initiated by the network node so that transmission to the wireless device is provided through a network node including a transceiver (e.g., through a base station or RAN node). According to embodiments where the network node is a RAN node including a transceiver, initiating transmission may include transmitting through the transceiver.

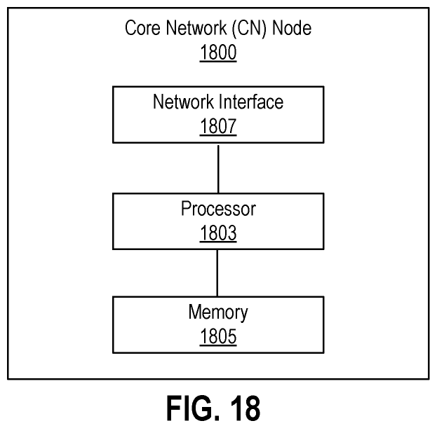

FIG. 18 is a block diagram illustrating elements of a core network CN node 1800 (e.g., an SMF node, an AMF node, etc.) of a communication network configured to provide cellular communication according to embodiments of inventive concepts. As shown, the CN node 1800 may include network interface circuitry 1807 (also referred to as a network interface) configured to provide communications with other nodes of the core network and/or the radio access network RAN. The CN node 1800 may also include a processing circuitry 1803 (also referred to as a processor) coupled to the network interface circuitry, and memory circuitry 1805 (also referred to as memory) coupled to the processing circuitry. The memory circuitry 1805 may include computer readable program code that when executed by the processing circuitry 1803 causes the processing circuitry to perform operations according to embodiments disclosed herein. According to other embodiments, processing circuitry 1803 may be defined to include memory so that a separate memory circuitry is not required.

As discussed herein, operations of the CN node 1800 may be performed by processing circuitry 1803 and/or network interface circuitry 1807. For example, processing circuitry 1803 may control network interface circuitry 1807 to transmit communications through network interface circuitry 1807 to one or more other network nodes and/or to receive communications through network interface circuitry from one or more other network nodes. Moreover, modules may be stored in memory 1805, and these modules may provide instructions so that when instructions of a module are executed by processing circuitry 1803, processing circuitry 1803 performs respective operations.

As discussed herein, operations of the UE 1600 may be performed by processing circuitry 1603 and/or transceiver 1601. For example, processing circuitry 1603 may control transceiver 1601 to transmit communications via antenna 1607 to one or more network nodes and/or to receive communications via antenna 1607 from one or more network nodes. Moreover, modules may be stored in memory 1605, and these modules may provide instructions so that when instructions of a module are executed by processing circuitry 1603, processing circuitry 1603 performs respective operations.

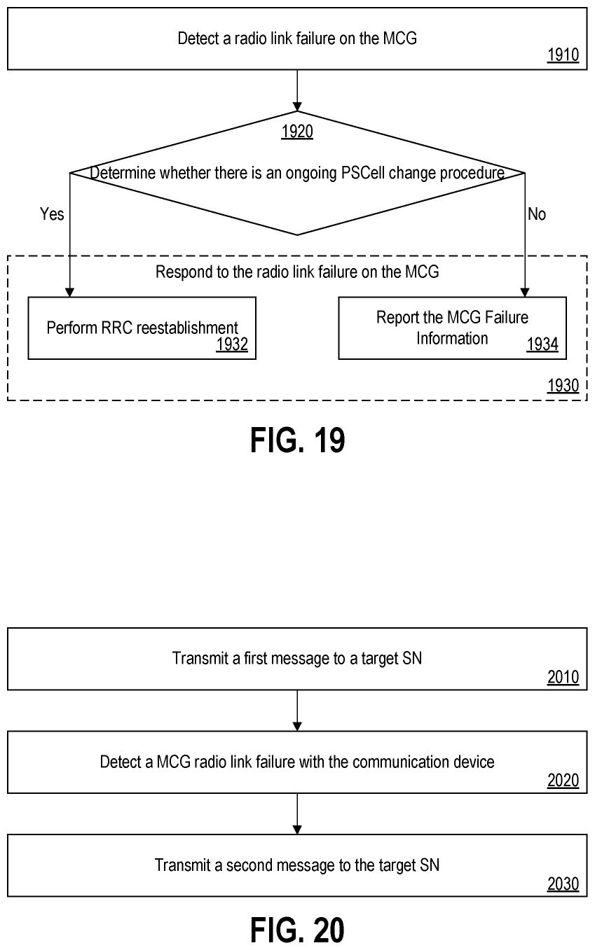

Operations of UE 1600 will now be discussed with reference to FIG. 19 according to some embodiments of inventive concepts. For example, modules (also referred to as units) may be stored in memory 1605 of FIG. 16, and these modules may provide instructions so that when the instructions of a module are executed by processing circuitry 1603, processing circuitry 1603 performs respective operations of the flow chart of FIG. 19.

FIG. 19 depicts a flow chart illustrating an example of a process for operating a communication device to respond to a radio link failure on the MCG. The communication device can be configured to operate in DC with a MN and a SN, and the communication device can be configured with a MCG configuration associated with the MN and a SCG configuration associated with the SN.

At block 1910, processing circuitry 1603 detects a radio link failure on the MCG.

At block 1920, processing circuitry 1603 determines whether there is an ongoing PSCell change procedure.

At block 1930, processing circuitry 1603, responds to the radio link failure on the MCG. In some embodiments, responding to the radio link failure is based on whether the PSCell change procedure is ongoing. In additional or alternative embodiments, responding to the radio link failure on the MCG is further based on whether the PSCell change procedure includes reconfiguring the DC to be between the MN and a different SN. In additional or alternative embodiments, responding to the radio link failure on the MCG is further based on whether the PSCell change procedure includes changing the PSCell to be a different cell within the SN.

In some embodiments, determining whether the PSCell change procedure is ongoing includes determining whether a timer for the PSCell is running. In additional or alternative embodiments, the MN and the SN are operating in a NR network, and the DC is a NR-DC. Determining whether the SCG change procedure is ongoing includes determining whether a timer for the PSCell is running. At block 1932, responsive to determining that there is an ongoing PSCell change procedure, processing circuitry 1603 performs RRC re-establishment.

In some embodiments, the MN operates in a long term evolution, LTE, network, the SN operates in a NR network, and the DC is a EN-DC. Determining whether the PSCell change procedure is ongoing includes determining whether a timer for the PSCell is not running. At block 1934, processing circuitry 1603, responsive to determining that there is not an ongoing PSCell change procedure, reports the MCG failure information.

In some embodiments, responding to the radio link failure on the MCG includes, responsive to detecting the radio link failure, always performing a RRC reestablishment.

Various operations of FIG. 19 may be optional with respect to some embodiments. For example, in regards to Embodiment 1 (described below), blocks 1932 and 1934 may be optional.

Operations of RAN node 1700 will now be discussed with reference to FIG. 20 according to some embodiments of inventive concepts. For example, modules (also referred to as units) may be stored in memory 1705 of FIG. 17, and these modules may provide instructions so that when the instructions of a module are executed by processing circuitry 1703, processing circuitry 1703 performs respective operations of the flow chart of FIG. 20.

FIG. 20 depicts a flow chart illustrating an example of a process for a first network node (1700) to handle a MCG radio link failure between the first network node and a communication device. The communication device can be configured to operate in DC with a MN and a SN. The first network node can be the MN.

At block 2010, processing circuitry 1703 transmits, via transceiver 1701, a first message to a target SN. In some embodiments, the first message can be part of a PSCell change procedure. In some embodiments, the target SN is a different network node than the SN and the PSCell change procedure includes reconfiguring the DC to be with the MN and the target SN. In additional or alternative embodiments, the target SN is the SN and the PSCell change procedure includes changing the PSCell to be a different cell within the SN. In additional or alternative embodiments, the DC includes at least one of: a NR-DC and an EN-DC.

At block 2020, processing circuitry 1703 detects a MCG radio link failure with the communication device. In some embodiments, detecting the MCG radio link failure between the first network node and the communication device includes receiving a communication device context request from a third network node in the communications network. The third network node may have become the MN for the communication device. In additional or alternative embodiments, detecting the MCG radio link failure between the first network node and the communication device includes receiving a RRC reestablishment request message from the communication device.

At block 2030, processing circuitry 1703 transmits, via transceiver 1701, a second message to the target SN. In some embodiments, the second message is a SN release request message.

Various operations of FIG. 20 may be optional with respect to some embodiments.

Example Embodiments are discussed below. Reference numbers/letters are provided in parenthesis by way of example/illustration without limiting example embodiments to particular elements indicated by reference numbers/letters.

Embodiment 1. A method of operating a communication device configured to operate in dual connectivity, DC, with a master node, MN, and a secondary node, SN, and configured with a master cell group, MCG, configuration associated with the MN and a secondary cell group, SCG, configuration associated with the SN, the method comprising:

detecting (1910) a radio link failure on the MCG;

determining (1920) whether a primary secondary cell group cell, PSCell, change procedure is ongoing; and

responding (1930) to the radio link failure on the MCG based on whether the PSCell change procedure is ongoing.

Embodiment 2. The method of Embodiment 1, wherein responding to the radio link failure on the MCG is further based on whether the PSCell change procedure includes reconfiguring the DC to be between the MN and a different SN.

Embodiment 3. The method of Embodiment 1, wherein responding to the radio link failure on the MCG is further based on whether the PSCell change procedure includes changing the PSCell to be a different cell within the SN.

Embodiment 4. The method of any of Embodiments 1-3, wherein determining whether the PSCell change procedure is ongoing comprises determining whether a timer for the PSCell is running.

Embodiment 5. The method of Embodiment 4, wherein determining whether the PSCell change procedure is ongoing comprises determining whether a timer for the PSCell is running.

Embodiment 6. The method of Embodiment 5, wherein responding to the radio link failure on the MCG comprises, responsive to determining that the timer is running, performing (1932) a radio resource control, RRC, reestablishment.

Embodiment 7. The method of Embodiment 4, wherein determining whether the PSCell change procedure is ongoing comprises determining whether a timer for the PSCell is not running.

Embodiment 8. The method of Embodiment 7, wherein responding to the radio link failure on the MCG comprises, responsive to determining that the timer is not running, reporting (1934) MCG failure information.

Embodiment 9. The method of any of Embodiments 1-8, wherein the DC comprises one of: a new radio-new radio dual connectivity, NR-DC; an evolved universal terrestrial radio access new radio dual connectivity connected to evolved packet core, EN-DC; an evolved universal terrestrial radio access new radio dual connectivity connected to 5^{th} generation core, NGEN-DC; a new radio evolved universal terrestrial radio access new dual connectivity, NE-DC; or a multi-radio dual connectivity, MR-DC.

Embodiment 10. A method of operating a first network node in a communications network that includes a communication device configured to operate in dual connectivity, DC, with a master node, MN, and a secondary node, SN, the first network node being the MN, the method comprising:

transmitting (2010) a first message to a target SN as part of a primary secondary cell group cell, PSCell, change procedure being performed by the communication device;

detecting (2020) a master cell group, MCG, radio link failure between the first network node and the communication device; and

responsive (2030) to detecting the MCG radio link failure, transmitting a second message to the target SN.

Embodiment 11. The method of Embodiment 10, wherein transmitting the second message to the target SN comprises transmitting a SN release request message.

Embodiment 12. The method of any of Embodiments 10-11, wherein detecting the MCG radio link failure between the first network node and the communication device comprises receiving a communication device context request from a third network node in the communications network, the third network node having received at least one message from the communication device.

Embodiment 13. The method of any of Embodiments 10-11, wherein detecting the MCG radio link failure between the first network node and the communication device comprises receiving a radio resource control, RRC, reestablishment request message from the communication device.

Embodiment 14. The method of any of Embodiments 10-13, wherein the target SN is a different network node than the SN, and wherein the PSCell change procedure includes reconfiguring the DC to be with the MN and the target SN.

Embodiment 15. The method of any of Embodiments 10-13, wherein the target SN is the SN, and wherein the PSCell change procedure includes changing the PSCell to be a different cell within the SN.

Embodiment 16. The method of any of Embodiments 10-15, wherein the DC comprises one of: a new radio-new radio dual connectivity, NR-DC; an evolved universal terrestrial radio access new radio dual connectivity connected to evolved packet core, EN-DC; an evolved universal terrestrial radio access new radio dual connectivity connected to 5^{th} generation core, NGEN-DC; a new radio evolved universal terrestrial radio access new dual connectivity, NE-DC; or a multi-radio dual connectivity, MR-DC.

Embodiment 17. A communication device (1600) configured to operate in dual connectivity, DC, with a master node, MN, and a secondary node, SN, and configured with a master cell group, MCG, configuration associated with the MN and a secondary cell group, SCG, configuration associated with the SN, the communication device comprising:

processing circuitry (1603); and

memory (1605) coupled to the processing circuitry and having instructions stored therein that are executable by the processing circuitry to cause the communication device to perform operations comprising:
detecting (1910) a radio link failure on the MCG;
determining (1920) whether a primary secondary cell group cell, PSCell, change procedure is ongoing; and
responding (1930) to the radio link failure on the MCG based on whether the PSCell change procedure is ongoing.

Embodiment 18. The communication device of Embodiment 17, wherein responding to the radio link failure on the MCG is further based on whether the PSCell change procedure includes reconfiguring the DC to be between the MN and a different SN.

Embodiment 19. The communication device of Embodiment 17, wherein responding to the radio link failure on the MCG is further based on whether the PSCell change procedure includes changing the PSCell to be a different cell within the SN.

Embodiment 20. The communication device of any of Embodiments 17-19, wherein determining whether the PSCell change procedure is ongoing comprises determining whether a timer for the PSCell is running.

Embodiment 21. The communication device of Embodiment 20, wherein determining whether the PSCell change procedure is ongoing comprises determining whether a timer for the PSCell is running.

Embodiment 22. The communication device of Embodiment 21, wherein responding to the radio link failure on the MCG comprises, responsive to determining that the timer is running, performing (1932) a radio resource control, RRC, reestablishment.

Embodiment 23. The communication device of Embodiment 20, wherein determining whether the PSCell change procedure is ongoing comprises determining whether a timer for the PSCell is not running.

Embodiment 24. The communication device of Embodiment 23, wherein responding to the radio link failure on the MCG comprises, responsive to determining that the timer is not running, reporting (1934) MCG failure information.

Embodiment 25. The communication device of any of Embodiments 17-24, wherein the DC comprises one of: a new radio-new radio dual connectivity, NR-DC; an evolved universal terrestrial radio access new radio dual connectivity connected to evolved packet core, EN-DC; an evolved universal terrestrial radio access new radio dual connectivity connected to 5^{th} generation core, NGEN-DC; a new radio evolved universal terrestrial radio access new dual connectivity, NE-DC; or a multi-radio dual connectivity, MR-DC.

Embodiment 26. A communication device (1600) configured to operate in dual connectivity, DC, with a master node, MN, and a secondary node, SN, and configured with a master cell group, MCG, configuration associated with the MN and a secondary cell group, SCG, configuration associated with the SN and adapted to perform operations comprising:

detecting (1910) a radio link failure on the MCG;

determining (1920) whether a primary secondary cell group cell, PSCell, change procedure is ongoing; and

responding (1930) to the radio link failure on the MCG based on whether the PSCell change procedure is ongoing.

Embodiment 27. The communication device of Embodiment 26, wherein the operations comprise any of the operations of Embodiments 2-9.

Embodiment 28. A computer program comprising program code to be executed by processing circuitry (1603) of a communication device (1600) configured to operate in dual connectivity, DC, with a master node, MN, and a secondary node, SN, and configured with a master cell group, MCG, configuration associated with the MN and a secondary cell group, SCG, configuration associated with the SN, whereby execution of the program code causes the communication device to perform operations comprising:

detecting (1910) a radio link failure on the MCG;

determining (1920) whether a primary secondary cell group cell, PSCell, change procedure is ongoing; and

responding (1930) to the radio link failure on the MCG based on whether the PSCell change procedure is ongoing.

Embodiment 29. The computer program of Embodiment 28, the operations further comprising any of the operations of Embodiments 2-9.

Embodiment 30. A computer program product comprising a non-transitory storage medium including program code to be executed by processing circuitry (1603) of a communication device (1600) configured to operate in dual connectivity, DC, with a master node, MN, and a secondary node, SN, and configured with a master cell group, MCG, configuration associated with the MN and a secondary cell group, SCG, configuration associated with the SN, whereby execution of the program code causes the communication device to perform operations, the operations comprising:

detecting (1910) a radio link failure on the MCG;

determining (1920) whether a primary secondary cell group cell, PSCell, change procedure is ongoing; and

responding (1930) to the radio link failure on the MCG based on whether the PSCell change procedure is ongoing.

Embodiment 31. The computer program product of Embodiment 30, the operations further comprising any of the operations of Embodiments 2-9.

Embodiment 32. A first network node (1700) in a communications network that includes a communication device configured to operate in dual connectivity, DC, with a master node, MN, and a secondary node, SN, the first network node being the MN, the first network node comprising:

processing circuitry (1703); and

memory (1705) coupled to the processing circuitry and having instructions stored therein that are executable by the processing circuitry to cause the first network node to perform operations comprising:
transmitting (2010) a first message to a target SN as part of a primary secondary cell group cell, PSCell, change procedure being performed by the communication device;
detecting (2020) a master cell group, MCG, radio link failure between the first network node and the communication device; and
responsive (2030) to detecting the MCG radio link failure, transmitting a second message to the target SN.

Embodiment 33. The first network node of Embodiment 32, wherein transmitting the second message to the target SN comprises transmitting a SN release request message.

Embodiment 34. The first network node of any of Embodiments 32-33, wherein detecting the MCG radio link failure between the first network node and the communication device comprises receiving a communication device context request from a third network node in the communications network, the third network node having received at least one message from the communication device.

Embodiment 35. The first network node of any of Embodiments 32-33, wherein detecting the MCG radio link failure between the first network node and the communication device comprises receiving a radio resource control, RRC, reestablishment request message from the communication device.

Embodiment 36. The first network node of any of Embodiments 33-35, wherein the target SN is a different network node than the SN, and

wherein the PSCell change procedure includes reconfiguring the DC to be with the MN and the target SN.

Embodiment 37. The first network node of any of Embodiments 33-35, wherein the target SN is the SN, and

wherein the PSCell change procedure includes changing the PSCell to be a different cell within the SN.

Embodiment 38. The first network node of any of Embodiments 33-37, wherein the DC comprises one of: a new radio-new radio dual connectivity, NR-DC; an evolved universal terrestrial radio access new radio dual connectivity connected to evolved packet core, EN-DC; an evolved universal terrestrial radio access new radio dual connectivity connected to 5^{th} generation core, NGEN-DC; a new radio evolved universal terrestrial radio access new dual connectivity, NE-DC; or a multi-radio dual connectivity, MR-DC.

Embodiment 39. A first network node (1700) in a communications network that includes a communication device configured to operate in dual connectivity, DC, with a master node, MN, and a secondary node, SN, the first network node being the MN and adapted to perform operations comprising:

transmitting (2010) a first message to a target SN as part of a primary secondary cell group cell, PSCell, change procedure being performed by the communication device;

detecting (2020) a master cell group, MCG, radio link failure between the first network node and the communication device; and

responsive (2030) to detecting the MCG radio link failure, transmitting a second message to the target SN.

Embodiment 40. The first network node of Embodiment 39, wherein the operations comprise any of the operations of Embodiments 11-16.

Embodiment 41. A computer program comprising program code to be executed by processing circuitry (1703) of a first network node (1700) in a communications network that includes a communication device configured to operate in dual connectivity, DC, with a master node, MN, and a secondary node, SN, the first network node being the MN, whereby execution of the program code causes the first network node to perform operations comprising:

transmitting (2010) a first message to a target SN as part of a primary secondary cell group cell, PSCell, change procedure being performed by the communication device;

detecting (2020) a master cell group, MCG, radio link failure between the first network node and the communication device; and

responsive (2030) to detecting the MCG radio link failure, transmitting a second message to the target SN.

Embodiment 42. The computer program of Embodiment 41, the operations further comprising any of the operations of Embodiments 11-16.

Embodiment 43. A computer program product comprising a non-transitory storage medium including program code to be executed by processing circuitry (1703) of a first network node (1700) in a communications network that includes a communication device configured to operate in dual connectivity, DC, with a master node, MN, and a secondary node, SN, the first network node being the MN, whereby execution of the program code causes the first network node to perform operations, the operations comprising:

transmitting (2010) a first message to a target SN as part of a primary secondary cell group cell, PSCell, change procedure being performed by the communication device;

detecting (2020) a master cell group, MCG, radio link failure between the first network node and the communication device; and

responsive (2030) to detecting the MCG radio link failure, transmitting a second message to the target SN.

Embodiment 44. The computer program product of Embodiment 43, the operations further comprising any of the operations of Embodiments 11-16.

Explanations for abbreviations from the above disclosure are provided below.

### Abbreviation Explanation

5GC 5G Core Network

5GS 5G System

AMF Access and Mobility Management Function

ACK Acknowledgment

AP Application Protocol

BSR Buffer Status Report

BWP Bandwidth Part

C-RNTI Cell Radio Network Temporary Identifier

CA Carrier Aggregation

CE Control Element

CP Control Plane

CQI Channel Quality Indicator

DC Dual Connectivity

DCI Downlink Control Information

DL Downlink

DRB Data Radio Bearer

eNB E-UTRAN NodeB

EN-DC E-UTRA-NR Dual Connectivity

E-UTRA Evolved Universal Mobile Terrestrial Radio Access

E-UTRAN Evolved Universal Mobile Terrestrial Radio Access Network

EPC Evolved Packet Core

EPS Evolved Packet System

E-RAB EUTRAN Radio Access Bearer

FDD Frequency Division Duplex

gNB NR base station

GTP-U GPRS Tunneling Protocol-User Plane

HO Handover

IP Internet Protocol

LTE Long Term Evolution

MAC Medium Access Control

MCG Master Cell Group

MeNB Master eNB

MgNB Master gNB

MME Mobility Management Entity

MN Master Node

MR Multi-RAT

MR-DC Multi-RAT Dual Connectivity

NACK Negative Acknowledgement

NG Next Generation

NR New Radio

PCell Primary Cell

PCI Physical Cell Identity

PDCP Packet Data Convergence Protocol

PSCell Primary SCell

PUSCH Physical Uplink Shared Channel

P-GW Packet Gateway

RAN Radio Access Network

RAT Radio Access Technology

RLC Radio Link Control

RLF Radio Link Failure

RRC Radio Resource Control

SMF Session Management Function

SCG Secondary Cell Group

SCell Secondary Cell

SCTP Stream Control Transmission Protocol

SeNB Secondary eNB

SINR Signal to Interference plus Noise Ratio

S-GW Serving Gateway

S-MN Source MN

SN Secondary Node

S-SN Source SN

SR Scheduling Request

SRB Signaling Radio Bearer

SUL Supplementary uplink

TDD Time Division Duplex

TEID Tunnel Endpoint Identifier

TNL Transport Network Layer

T-MN Target MN

TDD Time Division Duplex

TEID Tunnel Endpoint Identifier

TNL Transport Network Layer

UCI Uplink Control Information

UDP User Datagram Protocol

UE User Equipment

UL Uplink

UP User Plane

URLLC Ultra Reliable Low Latency Communication

X2 Interface between base stations

Additional explanation is provided below.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

FIG. 21 illustrates a wireless network in accordance with some embodiments.

Although the subject matter described herein may be implemented in any appropriate type of system using any suitable components, the embodiments disclosed herein are described in relation to a wireless network, such as the example wireless network illustrated in FIG. 21. For simplicity, the wireless network of FIG. 21 only depicts network 4106, network nodes 4160 and 4160b, and WDs 4110, 4110b, and 4110c (also referred to as mobile terminals). In practice, a wireless network may further include any additional elements suitable to support communication between wireless devices or between a wireless device and another communication device, such as a landline telephone, a service provider, or any other network node or end device. Of the illustrated components, network node 4160 and wireless device (WD) 4110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 4106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 4160 and WD 4110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 21, network node 4160 includes processing circuitry 4170, device readable medium 4180, interface 4190, auxiliary equipment 4184, power source 4186, power circuitry 4187, and antenna 4162. Although network node 4160 illustrated in the example wireless network of FIG. 21 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 4160 are depicted as single boxes located within a larger box, or nested within multiple boxes, in practice, a network node may comprise multiple different physical components that make up a single illustrated component (e.g., device readable medium 4180 may comprise multiple separate hard drives as well as multiple RAM modules).

Similarly, network node 4160 may be composed of multiple physically separate components (e.g., a NodeB component and a RNC component, or a BTS component and a BSC component, etc.), which may each have their own respective components. In certain scenarios in which network node 4160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 4160 may be configured to support multiple radio access technologies (RATs). In such embodiments, some components may be duplicated (e.g., separate device readable medium 4180 for the different RATs) and some components may be reused (e.g., the same antenna 4162 may be shared by the RATs). Network node 4160 may also include multiple sets of the various illustrated components for different wireless technologies integrated into network node 4160, such as, for example, GSM, WCDMA, LTE, NR, WiFi, or Bluetooth wireless technologies. These wireless technologies may be integrated into the same or different chip or set of chips and other components within network node 4160.

Processing circuitry 4170 is configured to perform any determining, calculating, or similar operations (e.g., certain obtaining operations) described herein as being provided by a network node. These operations performed by processing circuitry 4170 may include processing information obtained by processing circuitry 4170 by, for example, converting the obtained information into other information, comparing the obtained information or converted information to information stored in the network node, and/or performing one or more operations based on the obtained information or converted information, and as a result of said processing making a determination.

Processing circuitry 4170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 4160 components, such as device readable medium 4180, network node 4160 functionality. For example, processing circuitry 4170 may execute instructions stored in device readable medium 4180 or in memory within processing circuitry 4170. Such functionality may include providing any of the various wireless features, functions, or benefits discussed herein. In some embodiments, processing circuitry 4170 may include a system on a chip (SOC).

In some embodiments, processing circuitry 4170 may include one or more of radio frequency (RF) transceiver circuitry 4172 and baseband processing circuitry 4174. In some embodiments, radio frequency (RF) transceiver circuitry 4172 and baseband processing circuitry 4174 may be on separate chips (or sets of chips), boards, or units, such as radio units and digital units. In alternative embodiments, part or all of RF transceiver circuitry 4172 and baseband processing circuitry 4174 may be on the same chip or set of chips, boards, or units

In certain embodiments, some or all of the functionality described herein as being provided by a network node, base station, eNB or other such network device may be performed by processing circuitry 4170 executing instructions stored on device readable medium 4180 or memory within processing circuitry 4170. In alternative embodiments, some or all of the functionality may be provided by processing circuitry 4170 without executing instructions stored on a separate or discrete device readable medium, such as in a hard-wired manner. In any of those embodiments, whether executing instructions stored on a device readable storage medium or not, processing circuitry 4170 can be configured to perform the described functionality. The benefits provided by such functionality are not limited to processing circuitry 4170 alone or to other components of network node 4160, but are enjoyed by network node 4160 as a whole, and/or by end users and the wireless network generally.

Device readable medium 4180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 4170. Device readable medium 4180 may store any suitable instructions, data or information, including a computer program, software, an application including one or more of logic, rules, code, tables, etc. and/or other instructions capable of being executed by processing circuitry 4170 and, utilized by network node 4160. Device readable medium 4180 may be used to store any calculations made by processing circuitry 4170 and/or any data received via interface 4190. In some embodiments, processing circuitry 4170 and device readable medium 4180 may be considered to be integrated.

Interface 4190 is used in the wired or wireless communication of signalling and/or data between network node 4160, network 4106, and/or WDs 4110. As illustrated, interface 4190 comprises port(s)/terminal(s) 4194 to send and receive data, for example to and from network 4106 over a wired connection. Interface 4190 also includes radio front end circuitry 4192 that may be coupled to, or in certain embodiments a part of, antenna 4162. Radio front end circuitry 4192 comprises filters 4198 and amplifiers 4196. Radio front end circuitry 4192 may be connected to antenna 4162 and processing circuitry 4170. Radio front end circuitry may be configured to condition signals communicated between antenna 4162 and processing circuitry 4170. Radio front end circuitry 4192 may receive digital data that is to be sent out to other network nodes or WDs via a wireless connection. Radio front end circuitry 4192 may convert the digital data into a radio signal having the appropriate channel and bandwidth parameters using a combination of filters 4198 and/or amplifiers 4196. The radio signal may then be transmitted via antenna 4162. Similarly, when receiving data, antenna 4162 may collect radio signals which are then converted into digital data by radio front end circuitry 4192. The digital data may be passed to processing circuitry 4170. In other embodiments, the interface may comprise different components and/or different combinations of components.

In certain alternative embodiments, network node 4160 may not include separate radio front end circuitry 4192, instead, processing circuitry 4170 may comprise radio front end circuitry and may be connected to antenna 4162 without separate radio front end circuitry 4192. Similarly, in some embodiments, all or some of RF transceiver circuitry 4172 may be considered a part of interface 4190. In still other embodiments, interface 4190 may include one or more ports or terminals 4194, radio front end circuitry 4192, and RF transceiver circuitry 4172, as part of a radio unit (not shown), and interface 4190 may communicate with baseband processing circuitry 4174, which is part of a digital unit (not shown).

Antenna 4162 may include one or more antennas, or antenna arrays, configured to send and/or receive wireless signals. Antenna 4162 may be coupled to radio front end circuitry 4192 and may be any type of antenna capable of transmitting and receiving data and/or signals wirelessly. In some embodiments, antenna 4162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as M IMO. In certain embodiments, antenna 4162 may be separate from network node 4160 and may be connectable to network node 4160 through an interface or port.

Antenna 4162, interface 4190, and/or processing circuitry 4170 may be configured to perform any receiving operations and/or certain obtaining operations described herein as being performed by a network node. Any information, data and/or signals may be received from a wireless device, another network node and/or any other network equipment. Similarly, antenna 4162, interface 4190, and/or processing circuitry 4170 may be configured to perform any transmitting operations described herein as being performed by a network node. Any information, data and/or signals may be transmitted to a wireless device, another network node and/or any other network equipment.

Power circuitry 4187 may comprise, or be coupled to, power management circuitry and is configured to supply the components of network node 4160 with power for performing the functionality described herein. Power circuitry 4187 may receive power from power source 4186. Power source 4186 and/or power circuitry 4187 may be configured to provide power to the various components of network node 4160 in a form suitable for the respective components (e.g., at a voltage and current level needed for each respective component). Power source 4186 may either be included in, or external to, power circuitry 4187 and/or network node 4160. For example, network node 4160 may be connectable to an external power source (e.g., an electricity outlet) via an input circuitry or interface such as an electrical cable, whereby the external power source supplies power to power circuitry 4187. As a further example, power source 4186 may comprise a source of power in the form of a battery or battery pack which is connected to, or integrated in, power circuitry 4187. The battery may provide backup power should the external power source fail. Other types of power sources, such as photovoltaic devices, may also be used.

Alternative embodiments of network node 4160 may include additional components beyond those shown in FIG. 21 that may be responsible for providing certain aspects of the network node's functionality, including any of the functionality described herein and/or any functionality necessary to support the subject matter described herein. For example, network node 4160 may include user interface equipment to allow input of information into network node 4160 and to allow output of information from network node 4160. This may allow a user to perform diagnostic, maintenance, repair, and other administrative functions for network node 4160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 4110 includes antenna 4111, interface 4114, processing circuitry 4120, device readable medium 4130, user interface equipment 4132, auxiliary equipment 4134, power source 4136 and power circuitry 4137. WD 4110 may include multiple sets of one or more of the illustrated components for different wireless technologies supported by WD 4110, such as, for example, GSM, WCDMA, LTE, NR, WiFi, WiMAX, or Bluetooth wireless technologies, just to mention a few. These wireless technologies may be integrated into the same or different chips or set of chips as other components within WD 4110.

Antenna 4111 may include one or more antennas or antenna arrays, configured to send and/or receive wireless signals, and is connected to interface 4114. In certain alternative embodiments, antenna 4111 may be separate from WD 4110 and be connectable to WD 4110 through an interface or port. Antenna 4111, interface 4114, and/or processing circuitry 4120 may be configured to perform any receiving or transmitting operations described herein as being performed by a WD. Any information, data and/or signals may be received from a network node and/or another WD. In some embodiments, radio front end circuitry and/or antenna 4111 may be considered an interface.

As illustrated, interface 4114 comprises radio front end circuitry 4112 and antenna 4111. Radio front end circuitry 4112 comprise one or more filters 4118 and amplifiers 4116. Radio front end circuitry 4112 is connected to antenna 4111 and processing circuitry 4120, and is configured to condition signals communicated between antenna 4111 and processing circuitry 4120. Radio front end circuitry 4112 may be coupled to or a part of antenna 4111. In some embodiments, WD 4110 may not include separate radio front end circuitry 4112; rather, processing circuitry 4120 may comprise radio front end circuitry and may be connected to antenna 4111. Similarly, in some embodiments, some or all of RF transceiver circuitry 4122 may be considered a part of interface 4114. Radio front end circuitry 4112 may receive digital data that is to be sent out to other network nodes or WDs via a wireless connection. Radio front end circuitry 4112 may convert the digital data into a radio signal having the appropriate channel and bandwidth parameters using a combination of filters 4118 and/or amplifiers 4116. The radio signal may then be transmitted via antenna 4111. Similarly, when receiving data, antenna 4111 may collect radio signals which are then converted into digital data by radio front end circuitry 4112. The digital data may be passed to processing circuitry 4120. In other embodiments, the interface may comprise different components and/or different combinations of components.

Processing circuitry 4120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 4110 components, such as device readable medium 4130, WD 4110 functionality. Such functionality may include providing any of the various wireless features or benefits discussed herein. For example, processing circuitry 4120 may execute instructions stored in device readable medium 4130 or in memory within processing circuitry 4120 to provide the functionality disclosed herein.

As illustrated, processing circuitry 4120 includes one or more of RF transceiver circuitry 4122, baseband processing circuitry 4124, and application processing circuitry 4126. In other embodiments, the processing circuitry may comprise different components and/or different combinations of components. In certain embodiments processing circuitry 4120 of WD 4110 may comprise a SOC. In some embodiments, RF transceiver circuitry 4122, baseband processing circuitry 4124, and application processing circuitry 4126 may be on separate chips or sets of chips. In alternative embodiments, part or all of baseband processing circuitry 4124 and application processing circuitry 4126 may be combined into one chip or set of chips, and RF transceiver circuitry 4122 may be on a separate chip or set of chips. In still alternative embodiments, part or all of RF transceiver circuitry 4122 and baseband processing circuitry 4124 may be on the same chip or set of chips, and application processing circuitry 4126 may be on a separate chip or set of chips. In yet other alternative embodiments, part or all of RF transceiver circuitry 4122, baseband processing circuitry 4124, and application processing circuitry 4126 may be combined in the same chip or set of chips. In some embodiments, RF transceiver circuitry 4122 may be a part of interface 4114. RF transceiver circuitry 4122 may condition RF signals for processing circuitry 4120.

In certain embodiments, some or all of the functionality described herein as being performed by a WD may be provided by processing circuitry 4120 executing instructions stored on device readable medium 4130, which in certain embodiments may be a computer-readable storage medium. In alternative embodiments, some or all of the functionality may be provided by processing circuitry 4120 without executing instructions stored on a separate or discrete device readable storage medium, such as in a hard-wired manner. In any of those particular embodiments, whether executing instructions stored on a device readable storage medium or not, processing circuitry 4120 can be configured to perform the described functionality. The benefits provided by such functionality are not limited to processing circuitry 4120 alone or to other components of WD 4110, but are enjoyed by WD 4110 as a whole, and/or by end users and the wireless network generally.

Processing circuitry 4120 may be configured to perform any determining, calculating, or similar operations (e.g., certain obtaining operations) described herein as being performed by a WD. These operations, as performed by processing circuitry 4120, may include processing information obtained by processing circuitry 4120 by, for example, converting the obtained information into other information, comparing the obtained information or converted information to information stored by WD 4110, and/or performing one or more operations based on the obtained information or converted information, and as a result of said processing making a determination.

Device readable medium 4130 may be operable to store a computer program, software, an application including one or more of logic, rules, code, tables, etc. and/or other instructions capable of being executed by processing circuitry 4120. Device readable medium 4130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 4120. In some embodiments, processing circuitry 4120 and device readable medium 4130 may be considered to be integrated.

User interface equipment 4132 may provide components that allow for a human user to interact with WD 4110. Such interaction may be of many forms, such as visual, audial, tactile, etc. User interface equipment 4132 may be operable to produce output to the user and to allow the user to provide input to WD 4110. The type of interaction may vary depending on the type of user interface equipment 4132 installed in WD 4110. For example, if WD 4110 is a smart phone, the interaction may be via a touch screen; if WD 4110 is a smart meter, the interaction may be through a screen that provides usage (e.g., the number of gallons used) or a speaker that provides an audible alert (e.g., if smoke is detected). User interface equipment 4132 may include input interfaces, devices and circuits, and output interfaces, devices and circuits. User interface equipment 4132 is configured to allow input of information into WD 4110, and is connected to processing circuitry 4120 to allow processing circuitry 4120 to process the input information. User interface equipment 4132 may include, for example, a microphone, a proximity or other sensor, keys/buttons, a touch display, one or more cameras, a USB port, or other input circuitry. User interface equipment 4132 is also configured to allow output of information from WD 4110, and to allow processing circuitry 4120 to output information from WD 4110. User interface equipment 4132 may include, for example, a speaker, a display, vibrating circuitry, a USB port, a headphone interface, or other output circuitry. Using one or more input and output interfaces, devices, and circuits, of user interface equipment 4132, WD 4110 may communicate with end users and/or the wireless network, and allow them to benefit from the functionality described herein.

Auxiliary equipment 4134 is operable to provide more specific functionality which may not be generally performed by WDs. This may comprise specialized sensors for doing measurements for various purposes, interfaces for additional types of communication such as wired communications etc. The inclusion and type of components of auxiliary equipment 4134 may vary depending on the embodiment and/or scenario.

Power source 4136 may, in some embodiments, be in the form of a battery or battery pack. Other types of power sources, such as an external power source (e.g., an electricity outlet), photovoltaic devices or power cells, may also be used. WD 4110 may further comprise power circuitry 4137 for delivering power from power source 4136 to the various parts of WD 4110 which need power from power source 4136 to carry out any functionality described or indicated herein. Power circuitry 4137 may in certain embodiments comprise power management circuitry. Power circuitry 4137 may additionally or alternatively be operable to receive power from an external power source; in which case WD 4110 may be connectable to the external power source (such as an electricity outlet) via input circuitry or an interface such as an electrical power cable. Power circuitry 4137 may also in certain embodiments be operable to deliver power from an external power source to power source 4136. This may be, for example, for the charging of power source 4136. Power circuitry 4137 may perform any formatting, converting, or other modification to the power from power source 4136 to make the power suitable for the respective components of WD 4110 to which power is supplied.

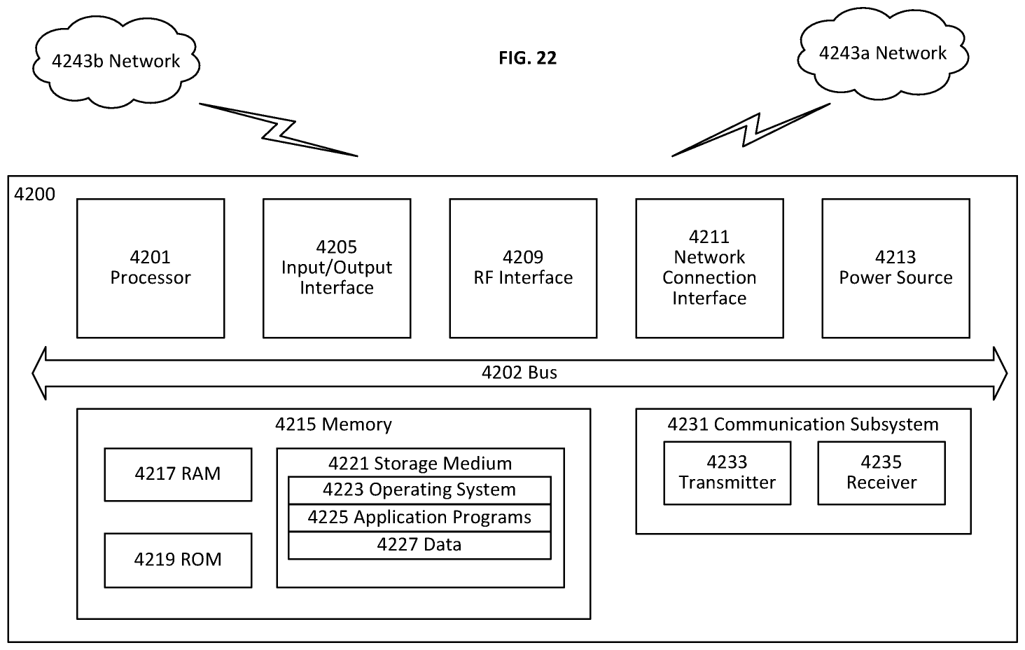

FIG. 22 illustrates a user Equipment in accordance with some embodiments.

FIG. 22 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 42200 may be any UE identified by the 3rd Generation Partnership Project (3GPP), including a NB-IoT UE, a machine type communication (MTC) UE, and/or an enhanced MTC (eMTC) UE. UE 4200, as illustrated in FIG. 22, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 22 is a UE, the components discussed herein are equally applicable to a WD, and vice-versa.

In FIG. 22, UE 4200 includes processing circuitry 4201 that is operatively coupled to input/output interface 4205, radio frequency (RF) interface 4209, network connection interface 4211, memory 4215 including random access memory (RAM) 4217, read-only memory (ROM) 4219, and storage medium 4221 or the like, communication subsystem 4231, power source 4213, and/or any other component, or any combination thereof. Storage medium 4221 includes operating system 4223, application program 4225, and data 4227. In other embodiments, storage medium 4221 may include other similar types of information. Certain UEs may utilize all of the components shown in FIG. 22, or only a subset of the components. The level of integration between the components may vary from one UE to another UE. Further, certain UEs may contain multiple instances of a component, such as multiple processors, memories, transceivers, transmitters, receivers, etc.

In FIG. 22, processing circuitry 4201 may be configured to process computer instructions and data. Processing circuitry 4201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 4201 may include two central processing units (CPUs). Data may be information in a form suitable for use by a computer.

In the depicted embodiment, input/output interface 4205 may be configured to provide a communication interface to an input device, output device, or input and output device. UE 4200 may be configured to use an output device via input/output interface 4205. An output device may use the same type of interface port as an input device. For example, a USB port may be used to provide input to and output from UE 4200. The output device may be a speaker, a sound card, a video card, a display, a monitor, a printer, an actuator, an emitter, a smartcard, another output device, or any combination thereof. UE 4200 may be configured to use an input device via input/output interface 4205 to allow a user to capture information into UE 4200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 22, RF interface 4209 may be configured to provide a communication interface to RF components such as a transmitter, a receiver, and an antenna. Network connection interface 4211 may be configured to provide a communication interface to network 4243a. Network 4243a may encompass wired and/or wireless networks such as a local-area network (LAN), a wide-area network (WAN), a computer network, a wireless network, a telecommunications network, another like network or any combination thereof. For example, network 4243a may comprise a Wi-Fi network. Network connection interface 4211 may be configured to include a receiver and a transmitter interface used to communicate with one or more other devices over a communication network according to one or more communication protocols, such as Ethernet, TCP/IP, SONET, ATM, or the like. Network connection interface 4211 may implement receiver and transmitter functionality appropriate to the communication network links (e.g., optical, electrical, and the like). The transmitter and receiver functions may share circuit components, software or firmware, or alternatively may be implemented separately.

RAM 4217 may be configured to interface via bus 4202 to processing circuitry 4201 to provide storage or caching of data or computer instructions during the execution of software programs such as the operating system, application programs, and device drivers. ROM 4219 may be configured to provide computer instructions or data to processing circuitry 4201. For example, ROM 4219 may be configured to store invariant low-level system code or data for basic system functions such as basic input and output (I/O), startup, or reception of keystrokes from a keyboard that are stored in a non-volatile memory. Storage medium 4221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 4221 may be configured to include operating system 4223, application program 4225 such as a web browser application, a widget or gadget engine or another application, and data file 4227. Storage medium 4221 may store, for use by UE 4200, any of a variety of various operating systems or combinations of operating systems.

Storage medium 4221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 4221 may allow UE 4200 to access computer-executable instructions, application programs or the like, stored on transitory or non-transitory memory media, to off-load data, or to upload data. An article of manufacture, such as one utilizing a communication system may be tangibly embodied in storage medium 4221, which may comprise a device readable medium.

In FIG. 22, processing circuitry 4201 may be configured to communicate with network 4243b using communication subsystem 4231. Network 4243a and network 4243b may be the same network or networks or different network or networks. Communication subsystem 4231 may be configured to include one or more transceivers used to communicate with network 4243b. For example, communication subsystem 4231 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 4233 and/or receiver 4235 to implement transmitter or receiver functionality, respectively, appropriate to the RAN links (e.g., frequency allocations and the like). Further, transmitter 4233 and receiver 4235 of each transceiver may share circuit components, software or firmware, or alternatively may be implemented separately.

In the illustrated embodiment, the communication functions of communication subsystem 4231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 4231 may include cellular communication, Wi-Fi communication, Bluetooth communication, and GPS communication. Network 4243b may encompass wired and/or wireless networks such as a local-area network (LAN), a wide-area network (WAN), a computer network, a wireless network, a telecommunications network, another like network or any combination thereof. For example, network 4243b may be a cellular network, a Wi-Fi network, and/or a near-field network. Power source 4213 may be configured to provide alternating current (AC) or direct current (DC) power to components of UE 4200.

The features, benefits and/or functions described herein may be implemented in one of the components of UE 4200 or partitioned across multiple components of UE 4200. Further, the features, benefits, and/or functions described herein may be implemented in any combination of hardware, software or firmware. In one example, communication subsystem 4231 may be configured to include any of the components described herein. Further, processing circuitry 4201 may be configured to communicate with any of such components over bus 4202. In another example, any of such components may be represented by program instructions stored in memory that when executed by processing circuitry 4201 perform the corresponding functions described herein. In another example, the functionality of any of such components may be partitioned between processing circuitry 4201 and communication subsystem 4231. In another example, the non-computationally intensive functions of any of such components may be implemented in software or firmware and the computationally intensive functions may be implemented in hardware.

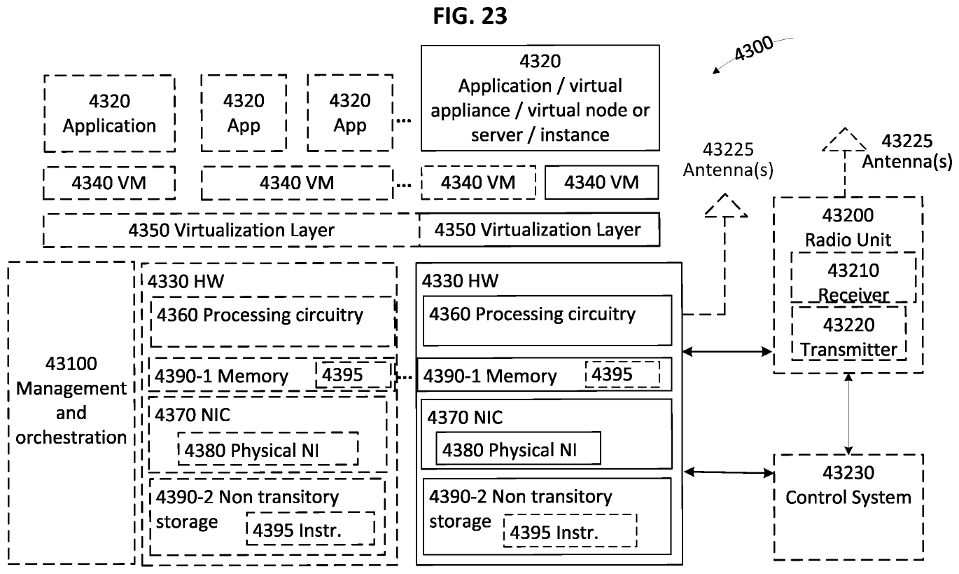

FIG. 23 illustrates a virtualization environment in accordance with some embodiments.

FIG. 23 is a schematic block diagram illustrating a virtualization environment 4300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 4300 hosted by one or more of hardware nodes 4330. Further, in embodiments in which the virtual node is not a radio access node or does not require radio connectivity (e.g., a core network node), then the network node may be entirely virtualized.

The functions may be implemented by one or more applications 4320 (which may alternatively be called software instances, virtual appliances, network functions, virtual nodes, virtual network functions, etc.) operative to implement some of the features, functions, and/or benefits of some of the embodiments disclosed herein. Applications 4320 are run in virtualization environment 4300 which provides hardware 4330 comprising processing circuitry 4360 and memory 4390. Memory 4390 contains instructions 4395 executable by processing circuitry 4360 whereby application 4320 is operative to provide one or more of the features, benefits, and/or functions disclosed herein.

Virtualization environment 4300, comprises general-purpose or special-purpose network hardware devices 4330 comprising a set of one or more processors or processing circuitry 4360, which may be commercial off-the-shelf (COTS) processors, dedicated Application Specific Integrated Circuits (ASICs), or any other type of processing circuitry including digital or analog hardware components or special purpose processors. Each hardware device may comprise memory 4390-1 which may be non-persistent memory for temporarily storing instructions 4395 or software executed by processing circuitry 4360. Each hardware device may comprise one or more network interface controllers (NICs) 4370, also known as network interface cards, which include physical network interface 4380. Each hardware device may also include non-transitory, persistent, machine-readable storage media 4390-2 having stored therein software 4395 and/or instructions executable by processing circuitry 4360. Software 4395 may include any type of software including software for instantiating one or more virtualization layers 4350 (also referred to as hypervisors), software to execute virtual machines 4340 as well as software allowing it to execute functions, features and/or benefits described in relation with some embodiments described herein.

Virtual machines 4340 comprise virtual processing, virtual memory, virtual networking or interface and virtual storage, and may be run by a corresponding virtualization layer 4350 or hypervisor. Different embodiments of the instance of virtual appliance 4320 may be implemented on one or more of virtual machines 4340, and the implementations may be made in different ways.

During operation, processing circuitry 4360 executes software 4395 to instantiate the hypervisor or virtualization layer 4350, which may sometimes be referred to as a virtual machine monitor (VMM). Virtualization layer 4350 may present a virtual operating platform that appears like networking hardware to virtual machine 4340.

As shown in FIG. 23, hardware 4330 may be a standalone network node with generic or specific components. Hardware 4330 may comprise antenna 43225 and may implement some functions via virtualization. Alternatively, hardware 4330 may be part of a larger cluster of hardware (e.g. such as in a data center or customer premise equipment (CPE)) where many hardware nodes work together and are managed via management and orchestration (MANO) 43100, which, among others, oversees lifecycle management of applications 4320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 4340 may be a software implementation of a physical machine that runs programs as if they were executing on a physical, non-virtualized machine. Each of virtual machines 4340, and that part of hardware 4330 that executes that virtual machine, be it hardware dedicated to that virtual machine and/or hardware shared by that virtual machine with others of the virtual machines 4340, forms a separate virtual network elements (VNE).

Still in the context of NFV, Virtual Network Function (VNF) is responsible for handling specific network functions that run in one or more virtual machines 4340 on top of hardware networking infrastructure 4330 and corresponds to application 4320 in FIG. 23.

In some embodiments, one or more radio units 43200 that each include one or more transmitters 43220 and one or more receivers 43210 may be coupled to one or more antennas 43225. Radio units 43200 may communicate directly with hardware nodes 4330 via one or more appropriate network interfaces and may be used in combination with the virtual components to provide a virtual node with radio capabilities, such as a radio access node or a base station.

In some embodiments, some signalling can be effected with the use of control system 43230 which may alternatively be used for communication between the hardware nodes 4330 and radio units 43200.

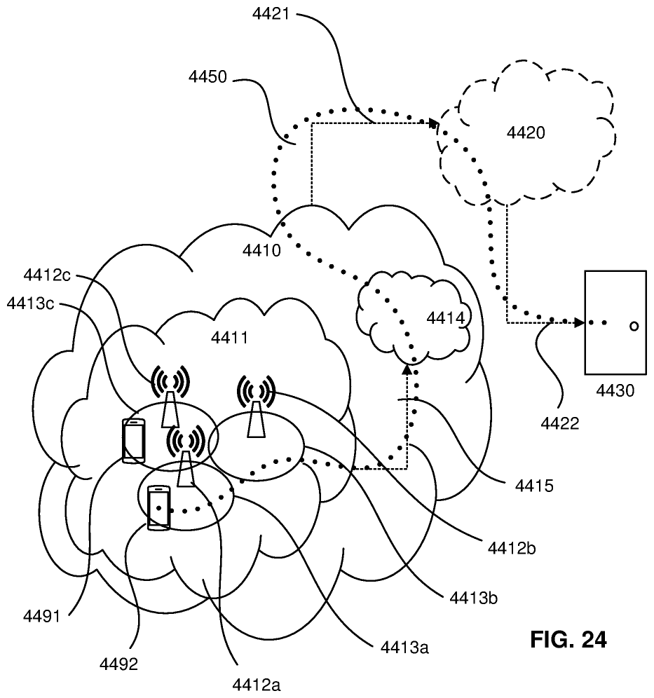

FIG. 24 illustrates a telecommunication network connected via an intermediate network to a host computer in accordance with some embodiments.

With reference to FIG. 24, in accordance with an embodiment, a communication system includes telecommunication network 4410, such as a 3GPP-type cellular network, which comprises access network 4411, such as a radio access network, and core network 4414. Access network 4411 comprises a plurality of base stations 4412a, 4412b, 4412c, such as NBs, eNBs, gNBs or other types of wireless access points, each defining a corresponding coverage area 4413a, 4413b, 4413c. Each base station 4412a, 4412b, 4412c is connectable to core network 4414 over a wired or wireless connection 4415. A first UE 4491 located in coverage area 4413c is configured to wirelessly connect to, or be paged by, the corresponding base station 4412c. A second UE 4492 in coverage area 4413a is wirelessly connectable to the corresponding base station 4412a. While a plurality of UEs 4491, 4492 are illustrated in this example, the disclosed embodiments are equally applicable to a situation where a sole UE is in the coverage area or where a sole UE is connecting to the corresponding base station 4412.

Telecommunication network 4410 is itself connected to host computer 4430, which may be embodied in the hardware and/or software of a standalone server, a cloud-implemented server, a distributed server or as processing resources in a server farm. Host computer 4430 may be under the ownership or control of a service provider, or may be operated by the service provider or on behalf of the service provider. Connections 4421 and 4422 between telecommunication network 4410 and host computer 4430 may extend directly from core network 4414 to host computer 4430 or may go via an optional intermediate network 4420. Intermediate network 4420 may be one of, or a combination of more than one of, a public, private or hosted network; intermediate network 4420, if any, may be a backbone network or the Internet; in particular, intermediate network 4420 may comprise two or more sub-networks (not shown).

The communication system of FIG. 24 as a whole enables connectivity between the connected UEs 4491, 4492 and host computer 4430. The connectivity may be described as an over-the-top (OTT) connection 4450. Host computer 4430 and the connected UEs 4491, 4492 are configured to communicate data and/or signaling via OTT connection 4450, using access network 4411, core network 4414, any intermediate network 4420 and possible further infrastructure (not shown) as intermediaries. OTT connection 4450 may be transparent in the sense that the participating communication devices through which OTT connection 4450 passes are unaware of routing of uplink and downlink communications. For example, base station 4412 may not or need not be informed about the past routing of an incoming downlink communication with data originating from host computer 4430 to be forwarded (e.g., handed over) to a connected UE 4491. Similarly, base station 4412 need not be aware of the future routing of an outgoing uplink communication originating from the UE 4491 towards the host computer 4430.

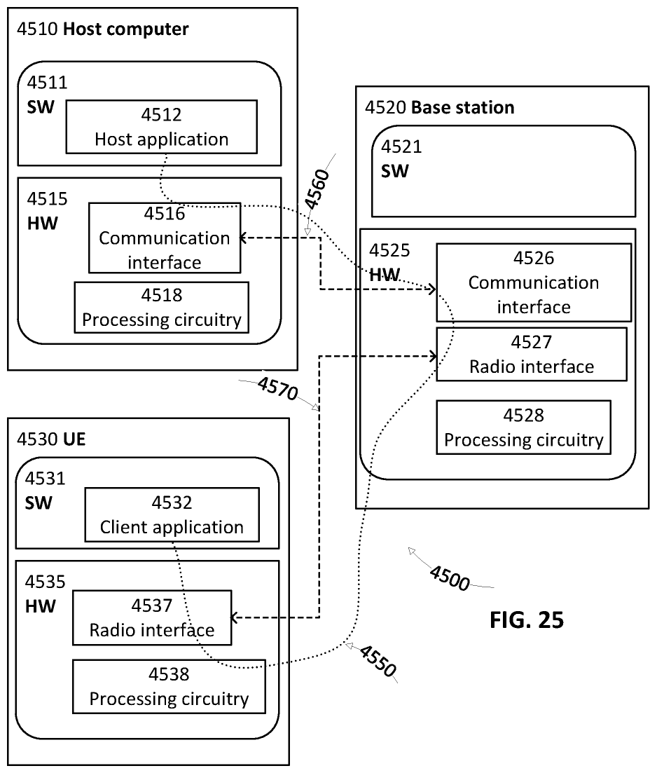

FIG. 25 illustrates a host computer communicating via a base station with a user equipment over a partially wireless connection in accordance with some embodiments.

Example implementations, in accordance with an embodiment, of the UE, base station and host computer discussed in the preceding paragraphs will now be described with reference to FIG. 25. In communication system 4500, host computer 4510 comprises hardware 4515 including communication interface 4516 configured to set up and maintain a wired or wireless connection with an interface of a different communication device of communication system 4500. Host computer 4510 further comprises processing circuitry 4518, which may have storage and/or processing capabilities. In particular, processing circuitry 4518 may comprise one or more programmable processors, application-specific integrated circuits, field programmable gate arrays or combinations of these (not shown) adapted to execute instructions. Host computer 4510 further comprises software 4511, which is stored in or accessible by host computer 4510 and executable by processing circuitry 4518. Software 4511 includes host application 4512. Host application 4512 may be operable to provide a service to a remote user, such as UE 4530 connecting via OTT connection 4550 terminating at UE 4530 and host computer 4510. In providing the service to the remote user, host application 4512 may provide user data which is transmitted using OTT connection 4550.

Communication system 4500 further includes base station 4520 provided in a telecommunication system and comprising hardware 4525 enabling it to communicate with host computer 4510 and with UE 4530. Hardware 4525 may include communication interface 4526 for setting up and maintaining a wired or wireless connection with an interface of a different communication device of communication system 4500, as well as radio interface 4527 for setting up and maintaining at least wireless connection 4570 with UE 4530 located in a coverage area (not shown in FIG. 25) served by base station 4520. Communication interface 4526 may be configured to facilitate connection 4560 to host computer 4510. Connection 4560 may be direct or it may pass through a core network (not shown in FIG. 25) of the telecommunication system and/or through one or more intermediate networks outside the telecommunication system. In the embodiment shown, hardware 4525 of base station 4520 further includes processing circuitry 4528, which may comprise one or more programmable processors, application-specific integrated circuits, field programmable gate arrays or combinations of these (not shown) adapted to execute instructions. Base station 4520 further has software 4521 stored internally or accessible via an external connection.

Communication system 4500 further includes UE 4530 already referred to. Its hardware 4535 may include radio interface 4537 configured to set up and maintain wireless connection 4570 with a base station serving a coverage area in which UE 4530 is currently located. Hardware 4535 of UE 4530 further includes processing circuitry 4538, which may comprise one or more programmable processors, application-specific integrated circuits, field programmable gate arrays or combinations of these (not shown) adapted to execute instructions. UE 4530 further comprises software 4531, which is stored in or accessible by UE 4530 and executable by processing circuitry 4538. Software 4531 includes client application 4532. Client application 4532 may be operable to provide a service to a human or non-human user via UE 4530, with the support of host computer 4510. In host computer 4510, an executing host application 4512 may communicate with the executing client application 4532 via OTT connection 4550 terminating at UE 4530 and host computer 4510. In providing the service to the user, client application 4532 may receive request data from host application 4512 and provide user data in response to the request data. OTT connection 4550 may transfer both the request data and the user data. Client application 4532 may interact with the user to generate the user data that it provides.

It is noted that host computer 4510, base station 4520 and UE 4530 illustrated in FIG. 25 may be similar or identical to host computer 4430, one of base stations 4412a, 4412b, 4412c and one of UEs 4491, 4492 of FIG. 24, respectively. This is to say, the inner workings of these entities may be as shown in FIG. 25 and independently, the surrounding network topology may be that of FIG. 24.

In FIG. 25, OTT connection 4550 has been drawn abstractly to illustrate the communication between host computer 4510 and UE 4530 via base station 4520, without explicit reference to any intermediary devices and the precise routing of messages via these devices. Network infrastructure may determine the routing, which it may be configured to hide from UE 4530 or from the service provider operating host computer 4510, or both. While OTT connection 4550 is active, the network infrastructure may further take decisions by which it dynamically changes the routing (e.g., on the basis of load balancing consideration or reconfiguration of the network).

Wireless connection 4570 between UE 4530 and base station 4520 is in accordance with the teachings of the embodiments described throughout this disclosure. One or more of the various embodiments may improve the performance of OTT services provided to UE 4530 using OTT connection 4550, in which wireless connection 4570 forms the last segment. More precisely, the teachings of these embodiments may improve the random access speed and/or reduce random access failure rates and thereby provide benefits such as faster and/or more reliable random access.

A measurement procedure may be provided for the purpose of monitoring data rate, latency and other factors on which the one or more embodiments improve. There may further be an optional network functionality for reconfiguring OTT connection 4550 between host computer 4510 and UE 4530, in response to variations in the measurement results. The measurement procedure and/or the network functionality for reconfiguring OTT connection 4550 may be implemented in software 4511 and hardware 4515 of host computer 4510 or in software 4531 and hardware 4535 of UE 4530, or both. In embodiments, sensors (not shown) may be deployed in or in association with communication devices through which OTT connection 4550 passes; the sensors may participate in the measurement procedure by supplying values of the monitored quantities exemplified above, or supplying values of other physical quantities from which software 4511, 4531 may compute or estimate the monitored quantities. The reconfiguring of OTT connection 4550 may include message format, retransmission settings, preferred routing etc.; the reconfiguring need not affect base station 4520, and it may be unknown or imperceptible to base station 4520. Such procedures and functionalities may be known and practiced in the art. In certain embodiments, measurements may involve proprietary UE signaling facilitating host computer 4510's measurements of throughput, propagation times, latency and the like. The measurements may be implemented in that software 4511 and 4531 causes messages to be transmitted, in particular empty or ‘dummy’ messages, using OTT connection 4550 while it monitors propagation times, errors etc.

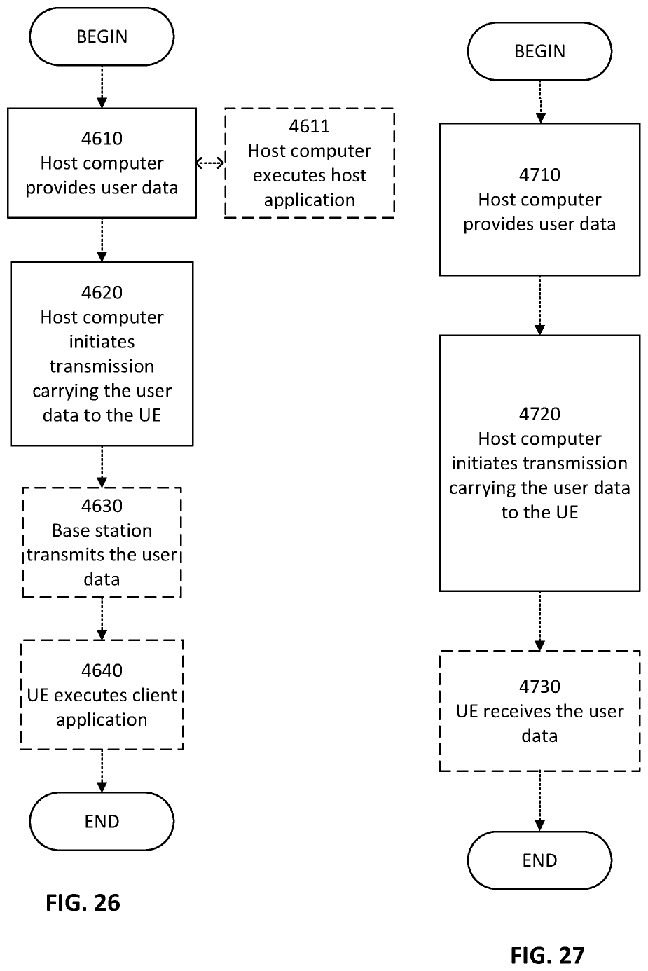

FIG. 26 illustrates methods implemented in a communication system including a host computer, a base station and a user equipment in accordance with some embodiments

FIG. 26 is a flowchart illustrating a method implemented in a communication system, in accordance with one embodiment. The communication system includes a host computer, a base station and a UE which may be those described with reference to FIGS. 24-25. For simplicity of the present disclosure, only drawing references to FIG. 26 will be included in this section. In step 4610, the host computer provides user data. In substep 4611 (which may be optional) of step 4610, the host computer provides the user data by executing a host application. In step 4620, the host computer initiates a transmission carrying the user data to the UE. In step 4630 (which may be optional), the base station transmits to the UE the user data which was carried in the transmission that the host computer initiated, in accordance with the teachings of the embodiments described throughout this disclosure. In step 4640 (which may also be optional), the UE executes a client application associated with the host application executed by the host computer.

FIG. 27 illustrates methods implemented in a communication system including a host computer, a base station and a user equipment in accordance with some embodiments.

FIG. 27 is a flowchart illustrating a method implemented in a communication system, in accordance with one embodiment. The communication system includes a host computer, a base station and a UE which may be those described with reference to FIGS. 24-25. For simplicity of the present disclosure, only drawing references to FIG. 27 will be included in this section. In step 4710 of the method, the host computer provides user data. In an optional substep (not shown) the host computer provides the user data by executing a host application. In step 4720, the host computer initiates a transmission carrying the user data to the UE. The transmission may pass via the base station, in accordance with the teachings of the embodiments described throughout this disclosure. In step 4730 (which may be optional), the UE receives the user data carried in the transmission.

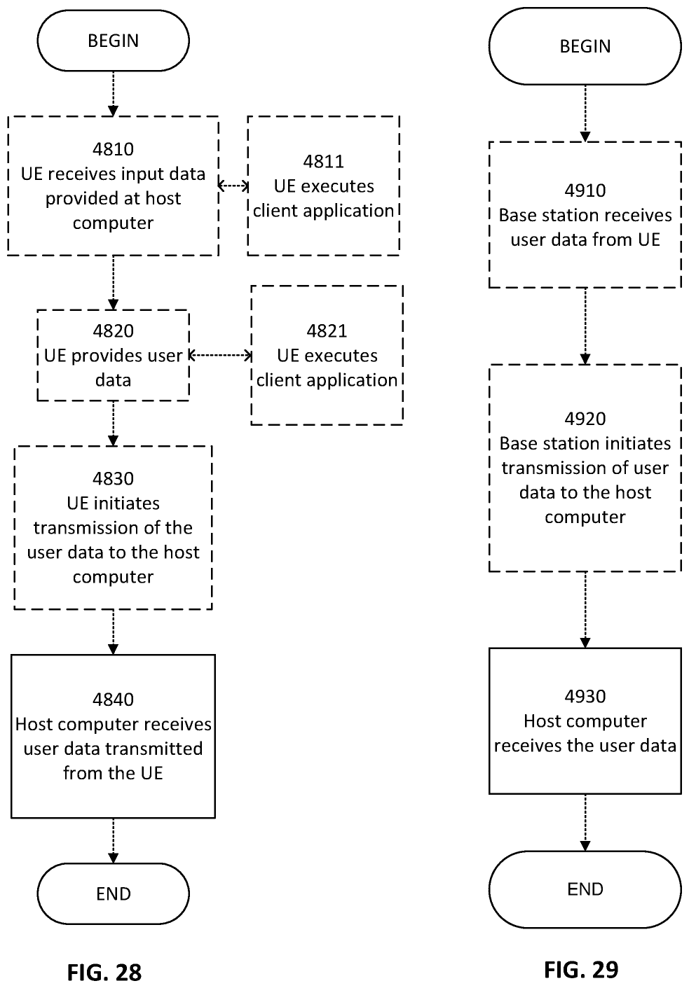

FIG. 28 illustrates methods implemented in a communication system including a host computer, a base station and a user equipment in accordance with some embodiments

FIG. 28 is a flowchart illustrating a method implemented in a communication system, in accordance with one embodiment. The communication system includes a host computer, a base station and a UE which may be those described with reference to FIGS. 24-25. For simplicity of the present disclosure, only drawing references to FIG. 28 will be included in this section. In step 4810 (which may be optional), the UE receives input data provided by the host computer. Additionally or alternatively, in step 4820, the UE provides user data. In substep 4821 (which may be optional) of step 4820, the UE provides the user data by executing a client application. In substep 4811 (which may be optional) of step 4810, the UE executes a client application which provides the user data in reaction to the received input data provided by the host computer. In providing the user data, the executed client application may further consider user input received from the user. Regardless of the specific manner in which the user data was provided, the UE initiates, in substep 4830 (which may be optional), transmission of the user data to the host computer. In step 4840 of the method, the host computer receives the user data transmitted from the UE, in accordance with the teachings of the embodiments described throughout this disclosure.

FIG. 29 illustrates methods implemented in a communication system including a host computer, a base station and a user equipment in accordance with some embodiments

FIG. 29 is a flowchart illustrating a method implemented in a communication system, in accordance with one embodiment. The communication system includes a host computer, a base station and a UE which may be those described with reference to FIGS. 24-25. For simplicity of the present disclosure, only drawing references to FIG. 29 will be included in this section. In step 4910 (which may be optional), in accordance with the teachings of the embodiments described throughout this disclosure, the base station receives user data from the UE. In step 4920 (which may be optional), the base station initiates transmission of the received user data to the host computer. In step 4930 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method of operating a communication device configured to operate in dual connectivity (DC) with a master node (MN) and a secondary node (SN) and configured with a master cell group (MCG) configuration associated with the MN and a secondary cell group (SCG) configuration associated with the SN, the method comprising:
detecting a radio link failure on the MCG;
determining whether a primary secondary cell group cell (PSCell) change procedure is ongoing, wherein determining whether the PSCell change procedure is ongoing comprises determining whether a timer for the PSCell is running; and
responding to the radio link failure on the MCG based on whether the PSCell change procedure is ongoing.

2. The method of claim 1, wherein responding to the radio link failure on the MCG is further based on whether the PSCell change procedure includes reconfiguring the DC to be between the MN and a different SN.

3. The method of claim 1, wherein responding to the radio link failure on the MCG is further based on whether the PSCell change procedure includes changing the PSCell to be a different cell within the SN.

4.-5. (canceled)

6. The method of claim 1, wherein responding to the radio link failure on the MCG comprises, responsive to determining that the timer is running, performing a radio resource control (RRC) reestablishment.

7. (canceled)

8. The method of claim 1, wherein responding to the radio link failure on the MCG comprises, responsive to determining that the timer is not running, reporting MCG failure information.

9. The method of claim 1, wherein the DC comprises one of: a new radio-new radio dual connectivity (NR-DC); an evolved universal terrestrial radio access new radio dual connectivity connected to evolved packet core (EN-DC); an evolved universal terrestrial radio access new radio dual connectivity connected to 5th generation core (NGEN-DC); a new radio evolved universal terrestrial radio access new dual connectivity (NE-DC); or a multi-radio dual connectivity (MR-DC).

10.-16. (canceled)

17. A communication device configured to operate in dual connectivity (DC) with a master node (MN) and a secondary node (SN) and configured with a master cell group (MCG) configuration associated with the MN and a secondary cell group (SCG) configuration associated with the SN, the communication device comprising:
processing circuitry; and
memory coupled to the processing circuitry and having instructions stored therein that are executable by the processing circuitry to cause the communication device to perform operations comprising:
detecting a radio link failure on the MCG;
determining whether a primary secondary cell group cell (PSCell) change procedure is ongoing, wherein determining whether the PSCell change procedure is ongoing comprises determining whether a timer for the PSCell is running; and
responding to the radio link failure on the MCG based on whether the PSCell change procedure is ongoing.

18. The communication device of claim 17, wherein responding to the radio link failure on the MCG is further based on whether the PSCell change procedure includes reconfiguring the DC to be between the MN and a different SN.

19. The communication device of claim 17, wherein responding to the radio link failure on the MCG is further based on whether the PSCell change procedure includes changing the PSCell to be a different cell within the SN.

20.-21. (canceled)

22. The communication device of claim 17, wherein responding to the radio link failure on the MCG comprises, responsive to determining that the timer is running, performing a radio resource control (RRC) reestablishment.

23. (canceled)

24. The communication device of claim 17, wherein responding to the radio link failure on the MCG comprises, responsive to determining that the timer is not running, reporting MCG failure information.

25. The communication device of claim 17, wherein the DC comprises one of: a new radio-new radio dual connectivity (NR-DC); an evolved universal terrestrial radio access new radio dual connectivity connected to evolved packet core (EN-DC); an evolved universal terrestrial radio access new radio dual connectivity connected to 5th generation core (NGEN-DC); a new radio evolved universal terrestrial radio access new dual connectivity (NE-DC); or a multi-radio dual connectivity (MR-DC).

26.-29. (canceled)

30. A computer program product comprising a non-transitory storage medium including program code to be executed by processing circuitry of a communication device configured to operate in dual connectivity (DC) with a master node (MN) and a secondary node (SN) and configured with a master cell group (MCG) configuration associated with the MN and a secondary cell group (SCG) configuration associated with the SN, whereby execution of the program code causes the communication device to perform operations comprising:
detecting a radio link failure on the MCG;
determining whether a primary secondary cell group cell (PSCell) change procedure is ongoing, wherein determining whether the PSCell change procedure is ongoing comprises determining whether a timer for the PSCell is running; and
responding to the radio link failure on the MCG based on whether the PSCell change procedure is ongoing.

31.-44. (canceled)

45. The computer program product of claim 30, wherein responding to the radio link failure on the MCG is further based on whether the PSCell change procedure includes reconfiguring the DC to be between the MN and a different SN.

46. The computer program product of claim 30, wherein responding to the radio link failure on the MCG is further based on whether the PSCell change procedure includes changing the PSCell to be a different cell within the SN.

47. The computer program product of claim 30, wherein responding to the radio link failure on the MCG comprises, responsive to determining that the timer is running, performing a radio resource control (RRC) reestablishment.

48. The computer program product of claim 30, wherein responding to the radio link failure on the MCG comprises, responsive to determining that the timer is not running, reporting MCG failure information.

49. The computer program product of claim 30, wherein the DC comprises one of: a new radio-new radio dual connectivity (NR-DC); an evolved universal terrestrial radio access new radio dual connectivity connected to evolved packet core (EN-DC); an evolved universal terrestrial radio access new radio dual connectivity connected to 5th generation core (NGEN-DC); a new radio evolved universal terrestrial radio access new dual connectivity (NE-DC); or a multi-radio dual connectivity (MR-DC).

50. The computer program product of claim 30, wherein the timer comprises a T304 or T307 timer.
